(19) United States
(12) Patent Application Publication
(10) Pub. No.: US 2006/0099641 A1
(43) Pub. Date: May 11, 2006

(54) Method of making libraries and anti-ligands

(76) Inventor: Mats Ohlin, Limhamn (SE)

Correspondence Address: KENYON & KENYON LLP, ONE BROADWAY, NEW YORK, NY, 10004, US

(21) Appl. No.: 10/503,433

(22) PCT Filed: Jan. 30, 2003
(86) PCT No.: PCT/EP03/00982

§ 371 Date: Aug. 3, 2005

(30) Foreign Application Priority Data
Jan. 31, 2002 (GB) 0202206.9

(51) Int. Cl. C40B 40/10

(52) U.S. Cl. 435/7.1

(57) ABSTRACT

The invention relates to methods of making anti-ligand libraries, which anti-ligands have a cavity binding site. The method comprises providing a plurality of anti-ligands having a cavity for binding a ligand, said plurality of anti-ligands being derived from a first anti-ligand having a cavity for binding a first ligand and differing from the first anti-ligand in that one or more of the amino acid residues which make up the ligand binding surface of the cavity are varied whereby the plurality of anti-ligands have a binding affinity for a first ligand which is different from that of the first anti-ligand, and wherein the one or more amino acid residues which is varied, is varied by replacement with one amino acid having similar but different physicochemical properties to the one or more amino acid residues, and wherein the one or more amino acids being varied can be varied to become a different amino acid in each anti-ligand molecule being varied. Preferably the anti-ligands are antibodies or fragments thereof which are capable of forming a cavity which can bind a ligand.

The present invention relates to a method of making libraries of anti-ligands, such as antibody molecules, which have a cavity binding site.

### BACKGROUND TO THE INVENTION

Molecular interactions between a ligand and its anti-ligand take place via interactions of complementary surfaces. Such interactions include the binding of: hormones to receptors; cytokines to receptors; viral proteins to cellular receptors; MHC-peptide complexes to T cell receptors; and antigens to antibodies.

For example, antibodies provide an organism with a source of binding molecules with diverse surfaces which are able to recognise a wide variety of targets such as toxins, bacterial structures, and viral structures.

The surface of an antibody that interacts with a foreign structure (the antigen) predominantly consists of six hypervariable loops that are held together by β-pleated sheets. These hypervariable loops are encoded by complementarity determining regions (CDRs), three of which are present on the variable domains of both the heavy and light chains of the immunoglobulin.

After the immunoglobulin peptide chains have been synthesised, protein folding brings these CDRs together in space to form the antigen-binding site (the paratope). The paratope is the portion of the hypervariable regions of the antibody that contacts the antigen.

All residues within a CDR are not equally important in interacting with the target antigen, as different residues contribute different properties to the binding site. Certain residues contribute mainly to the internal organisation of the binding site surface, others participate in the binding of the target antigen and the remainder, are located away from the binding surface (Kabat et al., 1991).

Those residues making up the binding site and that commonly make contact with antigens have been identified by analysis of a limited number of structures. (MacCallum et al. 1996). This work has shown that the more central residues within the binding site are those most commonly contacted by antigens and the less central residues are only contacted by large antigens. This finding allows one to predict those residues which are located in areas of the binding site which are most likely to contact the antigen.

Additionally MacCallum et al. (1996) identified four distinct topographic classes of binding site surfaces and their target types; they are concave and moderately concave (both hapten binding), ridged (peptide binding) and planar (protein binding). Antibodies also possess CDR regions irrespective of their binding site topography.

Concave and moderately concave binding sites, also known as cavity (or cavity type) binding sites, bind their targets with the ligand inside the cavity, hence access is restricted to small molecules of low molecular weight and small sized protrusions of larger molecules. In the case of antibodies, the cavity is therefore able to bind small low molecular weight immunogenic molecules (haptens) or small sized immunogenic protrusions of a larger molecule.

An individual antibody possesses only one of the four topographical types in its binding site. There are many different antibodies with different target antigens, and as such the total population of antibodies will have members representing all four binding site types. For example, the FITC antibodies of the present invention possess cavity type binding sites, while the B7 15A2 antibody contains a relatively flat active binding site to which protein antigen and peptide derivatives are held tightly to the outer surface without significant penetration into the interior (Faber et al., 1998). The AAAAA (Aho's Amazing Atlas of Antibody Anatomy) web site (www.biochem.unizh.ch/antibody) supports Faber et al. and suggests that an analysis of the binding modes of haptens, oligomers and proteins show different binding modes. Small haptens frequently embed themselves into the binding site which is of the cavity type. In contrast, proteins preferentially bind to a relatively flat binding surface. Not all antibody binding sites have been characterised but it is reasonable for a skilled person to assume that the binding site type will vary, at least partially, according to the target antigen.

Antigens are molecules that can either generate an antibody response (immunogens) themselves, or else are able to react with an antibody or primed T cell irrespective of its ability to generate them. The part of an antigen that contacts the antigen-binding site (paratope) is the epitope.

Haptens are a form of antigen. More specifically, haptens are small molecules of well defined chemical groupings that are able to bind a preformed antibody but fail to stimulate antibody production on their own. However they do become immunogenic when coupled to an appropriate carrier protein that is itself immunogenic.

Haptens are frequently important targets for antibodies as the need for specific antibodies in analysis of compounds such as hormones and drugs is very high. Many of these hapten molecules are predominantly hydrophobic structures (hydrocarbons) with a variable content of hydrophilic structures like hydroxyl and amino groups, and aromatic rings.

Haptens will bind into the binding site of those antibodies possessing cavities, as exemplified by Herron et al. (1989), Jeffrey et al. (1993), Lamminmäki et al. (2001), and Simon et al. (1998) (see FIG. 1). Such cavities therefore have surfaces complementary to the target, with hydrophobic patches as well as areas that can accommodate hydrophilic residues. In reality, the residues that line such a cavity will frequently be dominated by cyclic amino acids (tryptophan, tyrosine, phenylalanine, and histidine) with some involvement of non cyclic amino acids.

The identification of anti-ligands, such as proteins (for example, antibodies) with defined binding properties and target specificity has been facilitated recently by the development of a number of methods. For example, the use of display methods, such as (but not limited to) phage display (Smith, 1985) and ribosomal display (Hanes and Plückthun, 1997; and Mattheakis et al., 1994). These methods take the genetic material encoding the desired protein and link it to host genes for proteins that are synthesised and subsequently transported to the outer membrane and displayed on the exterior. Under the control of these host genes the desired protein is synthesised and displayed on the external surface where it can be screened for their binding properties. This method has the advantage that the gene(s) for the desired protein are located within the structure on which the protein is displayed. Consequently the gene is easy to isolate and characterise.

Another approach to the identification of anti-ligands is the application of the combinatorial principle in protein evolution, that is, the development of molecular protein libraries suitable for use in display technologies. This combinatorial principle relies on the combination of a whole gene or a portion of thereof from more than source.

Several types of antibody library have been devised (summarised by Söderlind et al., 2001), either directed towards recognising any type of antigen or a specific antigen. Those designed to recognise any type of target are made up of very large compilations of naturally derived or synthetic immunoglobulin genes. However, the large size of such libraries often makes them difficult to handle.

Those libraries specific for a single antigen are made up of immunoglobulin genes derived from mice or humans immunised with the target compound. Such genes would be highly enriched for those encoding specific antibodies recognising the antigen used in the immunisation procedure.

In only one case has a small synthetic library been devised that specifically took advantage of a presumed feature of a protein, namely an accumulation of charges in the epitope (Kirkham et al., 1999). The disclosure of Kirkham et al is incorporated herein by reference for, inter alia, the purpose of amendment including any amendment by disclaimer.

Kirkham et al took a synthetic antibody (anti-ligand) which was unable to bind a specific epitope (a first ligand) on the ribonuclease inhibitor protein barstar. Based on knowledge of the structure of a triangle of three negative charges on the face of barstar, the antibody was mutated to favour amino acid residues of opposite charge or those with hydrogen binding potential to the barstar residues. Other residues were mutated randomly. Using this method, Kirkham et al isolated an antibody which, unlike the parent antibody, could bind barstar.

U.S. Pat. No. 6,096,551 (Barbas et al.) describes the creation of random mutations in antibody fragment libraries with random synthetic sequence diversity targeted to the antigen binding site of antibodies that are not specifically those found within the wall of a cavity-type binding site.

Krykbaev et al. (2001) describes the evolution of a digoxin-specific antibody into variants exhibiting binding specificity against close analogues of digoxin; i.e. related specificities and not unrelated ones. Krykbaev focuses the randomised diversity being created into CDRH3 and not a cavity binding site.

Daugherty et al. (2000) discloses random mutagenesis and selection of affinity matured clones without the creation of cavity-type targeted libraries or selection of entirely new specificities.

Lamminmäki et al. (1999) describes a method whereby expansion of canonical loop length and random mutagenesis can be used to improve the affinity of an antibody to its original hapten antigen (without targeting a cavity), in order to create diversity to establish libraries with general hapten specificity.

Chames et al. (1998) describes affinity maturation of an antibody in relation to its original antigen only (and not other antigens) by targeting frequent contact residues in CDRH3 and CDRL3. The randomised mutation is created without prior knowledge of the physicochemical properties of the binding site.

Barbas et al (1993) describes the random generation of a general-purpose library by targeting CDRH3 and CDRL3 with random mutations and length diversification.

U.S. Pat. No. 5,965,408 (Short) describes a method to randomly diversify non cavity type molecules via sexual PCR for use in affinity screening.

The present inventors have followed a different approach which, unlike the methods described above, does not require prior knowledge of the structure of a given ligand and requires specific amino acids to be varied, i.e., does not rely on the introduction of random mutations.

### SUMMARY OF THE INVENTION

The invention provides methods for making libraries encoding anti-ligands having cavity binding sites, as defined in the accompanying claims.

The differing binding affinity for a first ligand can include a binding affinity of zero. In other words, one or more of the plurality of anti-ligands will not bind a first ligand.

Diversification of the cavity binding surface of the first anti-ligand is preferably achieved by site-directed mutagenesis of the portions of the gene(s) that form the cavity binding surface.

Preferably, a limitation is placed on variability such that the one or more amino acids which is varied, is varied by replacement by one or more amino acids having similar, but different, physiochemical properties.

Preferably, site-directed mutagenesis is conducted by using oligonucleotide primers to introduce diversity when used to amplify a selected region of anti-ligand by the polymerase chain reaction (PCR). The amplified portions are subsequently assembled to form the full sequence of the anti-ligand ready for expression from, or display on the surface of, an appropriate vector.

Preferably the anti-ligand is an antibody or fragment thereof which is capable of forming a cavity binding site, and the ligand is an antigen. More preferably, the ligand is a distinct antigen of low molecular weight or an antigenic low molecular weight protruding portion of a larger molecule.

In an alternative embodiment, the amino acid(s) which are varied are varied by replacement with amino acids from a natural CDR which make up a cavity binding site.

By “cavity binding site” we include the meaning of a surface that is able to bind to another complementary surface, the surface having a concave or moderately concave type binding site (see also MacCallum et al (1996)).

By “amino acid having similar but different physiochemical properties” we include the meaning that the amino acids will have similar charge; and/or hydrophobicity/hydrophilicity; and/or size; and/or structure; and/or volume inside the cavity binding site. Techniques for the measurement of such properties are within the general knowledge of skilled persons e.g. volume may be measured by X-Ray or NMR analysis of the antibody and further as disclosed by Fauchere, J et al (1988); Goldsack, D and Chalifoux, R (1973) and Bigelow, C (1967).

Amino acid residues can be generally sub-classified by their physicochemical properties. For example, they can be separated into groups of those containing cyclic group based side chains and those without. Those with no cyclic side chains can be further sub-classified into four major subclasses as follows and as shown in FIG. 8.

Acidic: The residue has a negative charge due to loss of H ion(s) at physiological pH. The residue is attracted by aqueous solution so as to seek the surface positions in the conformation of a peptide in which it is contained when the peptide is in aqueous medium at physiological pH.

Basic: The residue has a positive charge due to association with H ion(s) at physiological pH. The residue is attracted by aqueous solution so as to seek the surface positions in the conformation of a peptide in which it is contained when the peptide is in aqueous medium at physiological pH.

Neutral/Non-polar: The residues are not charged at physiological pH and the residue is repelled by aqueous solution so as to seek the inner positions in the conformation of a peptide which it is contained when the peptide is in aqueous medium.

Neutral/polar: The residues are not charged at physiological pH, but the residue is attracted by aqueous solution so as to seek the outer positions in the conformation of a peptide in which it is contained when the peptide is in aqueous medium.

For the purpose of this invention the 20 naturally occurring protein amino acids are preferably classified according to the foregoing scheme as follows (see also FIG. 8).

Cyclic: Tyrosine, Phenylalanine, Tryptophan and Histidine;

Non cyclic Acidic: Aspartic acid, Glutamic acid, Asparagine and Glutamine;

Non cyclic Basic: Arginine, Lysine;

Non cyclic Neutral Polar: Glycine, Serine, Cysteine and Threonine;

Non Cyclic Neutral Non-Polar: Alanine, Valine, Isoleucine, Leucine and Methionine.

The twentieth gene-encoded amino acid, proline, though technically a cyclic amino acid, is a unique case due to its known effects on the secondary conformation of peptide chains, and is not, therefore, included in a specific defined group.

A further commonly referred to grouping of amino acids is determined by is their interaction with water. Thus, those amino acids being repelled by aqueous solution (e.g. neutral non-polar) are also designated “hydrophobic” herein. All amino acids being attracted by aqueous solution are also designted “hydrophilic” herein.

By “low molecular weight” we include the meaning of an organic compound of molecular weight 100 to 3000 Da, calculated from the molecular weights of the constituent atoms. These low molecular weight ligands may insert fully or partially into the cavity binding site specific for that ligand and/or family of ligands.

The low molecular weight ligand may be one of, but not restricted to, steroids, carbohydrates, peptides, vitamins, lipids, aromatic compounds, aliphatic compounds, organic acids, organic bases, organic esters, organic amides, organic amines, organic ketones, organic aldehydes, organic alcohols, organometallic compounds, heterocyclic compounds or sulphur-containing compounds.

The low molecular weight ligand may also be a portion protruding from a larger molecule such as a protein, whereby the protruding portion preferably has a molecular weight of less than 3000 Da, the protrusion being capable of full or partial insertion into a cavity binding site. Examples of such protrusions include, a proteinaceous loop; and carbohydrate, lipid or other non-peptide protein modifications extending from the surface of the larger protein structure.

Examples embodying preferred aspects of the invention will now be described with reference to the accompanying figures in which:

### DESCRIPTION OF THE FIGURES

FIG. 1A—Anti-fluorescein antibody fragment 4-4-20 in complex with its antigen (green) (PDB: 4FAB) (Herron et al., 1989). Highlighted residues in the binding site include Trp103H (red), Phe98L (magenta), histidine (cyan), other aromatic residues (tryptophan and tyrosine) (orange), serine and threonine (yellow), arginine (blue) and a glutamine residue (green-blue).

FIG. 1B—Anti-4-hydroxy-5-iodo-3-nitrophenyl acetate bound to the B1-8 antibody fragment (PDB 1A6W) (Simon et al., 1998). The hapten is shown in green, aromatic residues (histidine, tyrosine and tryptophan) in orange, serine in yellow and positively charged residues (arginine and lysine) in blue.

FIG. 1C—Digoxin (green) bound to the 26-10 antibody fragment (PDB: 1IGJ) (Jeffrey et al., 1993). Highlighted residues include framework-encoded Tyr36L and Tyr47H residues (red) and Phe98L (magenta), as well as other aromatic residues (tyrosine, typtophan and histidine; orange), serine and threonine (yellow), asparagine (green-blue) and hydrophobic residues, methionine and valine, in blue and cyan, respectively.

FIG. 1D—anti-17β-estradiol complexed to its antigen (green) (PDB: 1JGL) (Lamminmäki et al., 2001). Highlighted residues include aromatic residues (orange), serine (yellow), glycine residues in CDRH3 (cyan) and aliphatic residues (red).

FIG. 2—Model structure of the F8 binding site with a cavity lined largely by aromatic (red), hydrophobic (orange) and serine (yellow) residues. A positively charged residue (arginine (blue) is also evident). The CDRH3 backbone is shown as in green.

FIG. 3—Primer annealing sites in the template. Codons carrying diversification are underlined. A misannealed base in primer 6 was included in the primer only to remove a restriction enzyme site in the template. Also shown are two similar primers allowing incorporation of diversification or not of two tryptophan residues in CDRH1 and CDRL3.

FIG. 4—Fragments incorporating mutations are amplified (A). After purification, the fragments (B) are assembled into a complete product (C) which after purification is cleaved by suitable restriction enzymes to form the fragments (D) that are suitable for cloning in the vector.

FIG. 5—Sequences of mutated clones picked at random. Diversity in randomised residues are boxed in green (within CDRH3) or in red (other residues). Some examples of other residues that may be targeted with diversity are boxed with hatched lines.

FIG. 6A—The mutation strategy had removed the ability of a few assessed clones to recognise the antigen recognised by the original P8 scFv and it had not introduced extensive multireactive binding properties into the binding site as judged by enzyme linked immunosorbent assay.

FIG. 6B—Individual clones picked at random from such a library frequently produced an antibody fragment, as shown by immunoblot detection.

FIG. 7—Natural diversity (de Wildt et al., 1999) in sequences derived from IgG originating from the DP-47 (IGHV3-23) germline gene. The natural diversity numbered by their GenBank accession code (AF103xxx) is compared with its germline gene origin as well as with the F8 sequence. The boxes represent diversity found in residues 56 and 58 in natural antibodies, which both are proposed targets of diversity in a cavity type library based on F8. This figure also gives an idea of the natural diversity available in genes originating from DP-47 if cavity type libraries targeting other residues are to be designed. By amplification of such sequences natural, functionally acceptable diversity can be introduced into the cavity library. Depending on the location of the primers used to amplify the natural diversity, sequence modifications other than those directly involved in the cavity itself can also be allowed in the library, if so desired.

FIG. 8—Amino acid classification scheme

FIG. 9—ELISA showing the ability of phages displaying scFv derived after 2-3 selections on (A) FITC-biotin/streptavidin (clones named FITC+ a number) or (B) NIP-BSA (clones named NIP+ a number) using different antigens coated at a high concentration (1 μg/ml). The antigens used were streptavidin, to which FITC-biotin were bound after immobilisation of the streptavidin, FITC-BSA, azobenzene arsonate-BSA (ABA-BSA), nitrophenyl-BSA (NP-BSA), NIP-BSA or BSA.

FIG. 10—ELISA defining the concentration dependent binding of scFv-displaying phages to (A) FITC-BSA and (B) NIP-BSA at a low concentration (40 ng/ml) coated onto microtitre plates. Clones selected on FITC-biotin/streptavidin were named FITCX (where the X is a number) while clones selected on NIP-BSA are identified by NIPX (where the X is a number). ScFv selected on NIP-BSA showed a good recognition of NIP but did not recognise FITC-BSA.

FIG. 11—Inhibition of the binding of scFv-displaying phages selected on (A) FITC-biotin/streptavidin or (B) NIP-BSA to their respective antigen (FITC-BSA or NIP-BSA) immobilised onto microtiter plates. Inhibition was carried out using either soluble FITC-BSA or NIP-BSA.

FIG. 12—Residues in mutated positions in scFv selected for reactivity towards FITC-biotin/streptavidin (FITC 2, FITC 3) or NIP-BSA (NIP 2, NIP 3, NIP 10). The sequence in the header refers to the sequence of the FITC8 scFv which was used as the starting point to create the new library. A “?” indicates an as yet not fully characterised residue.

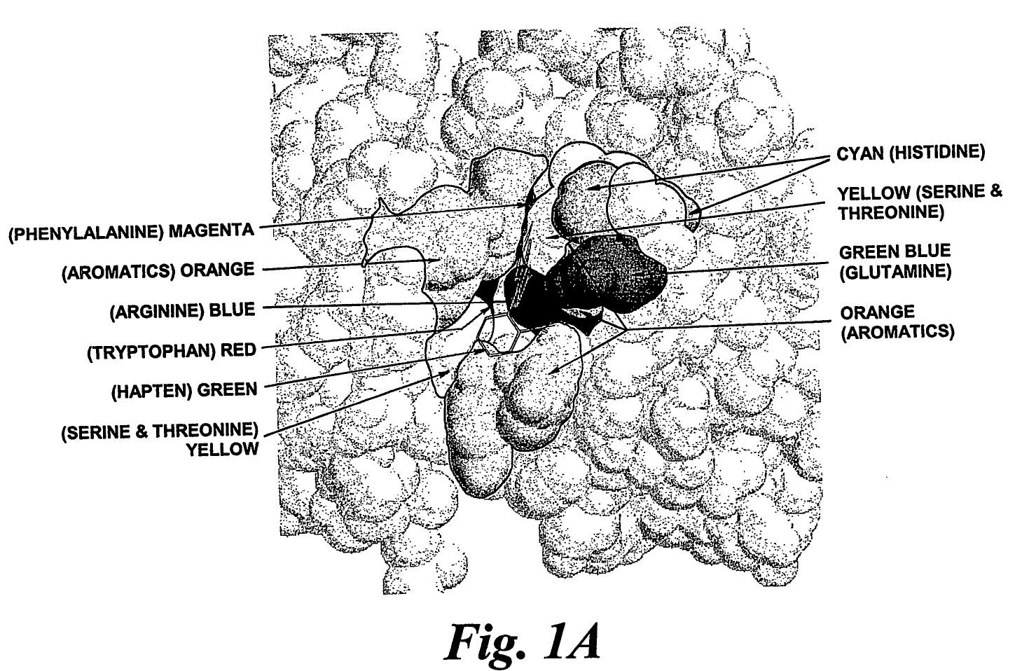

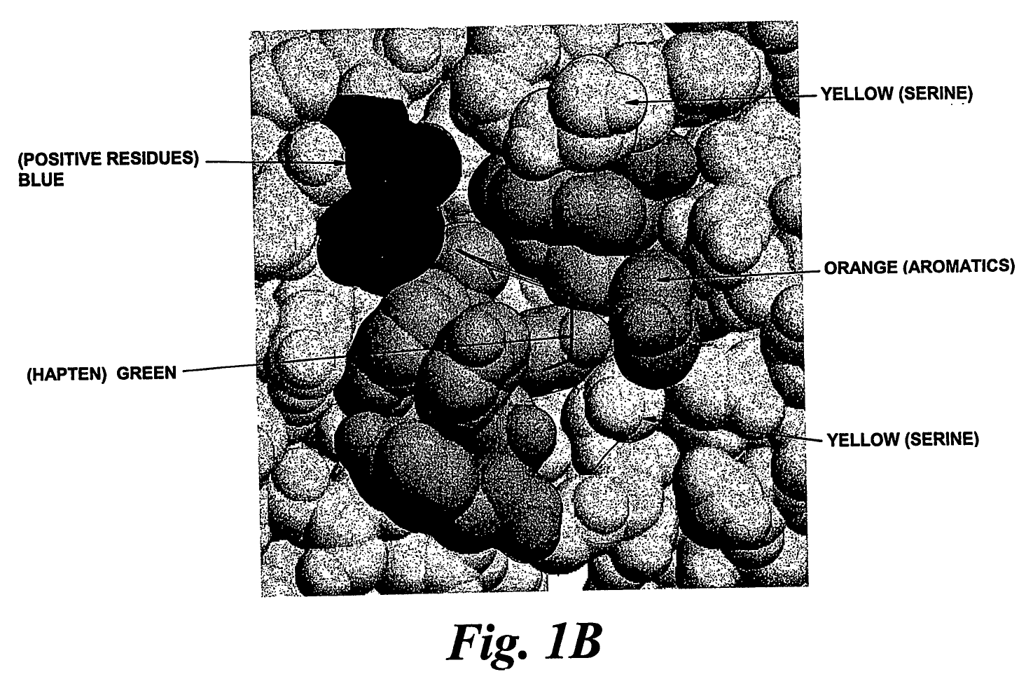

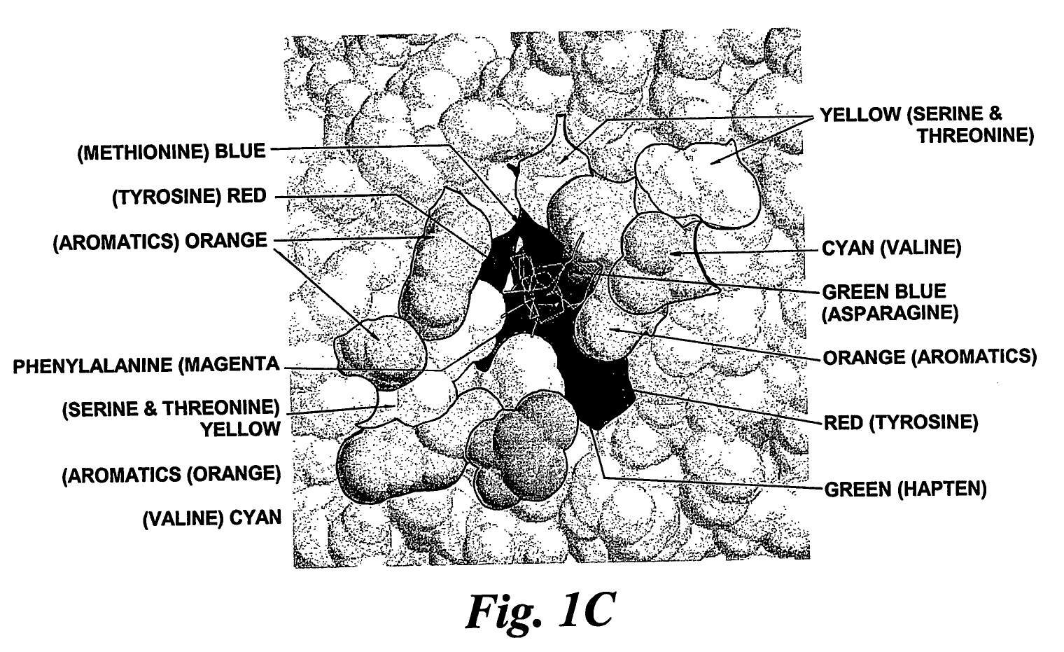

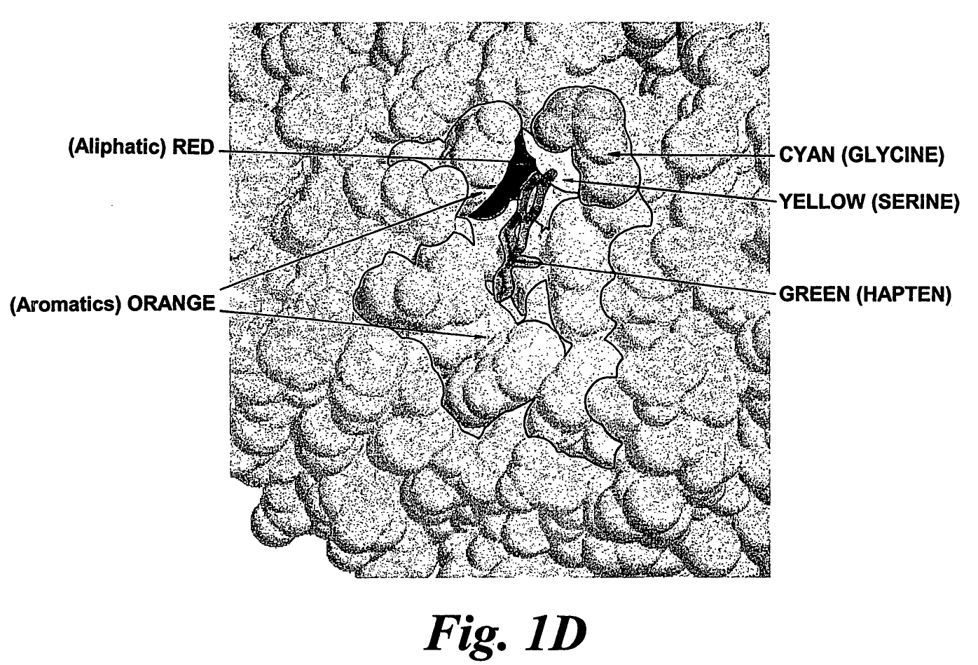

### EXAMPLES

### Example 1

### F8 scFv Diversification

The F8 scFv is an antibody fragment that recognises fluorescein isothiocyanate (FITC)-conjugated bovine serum albumin (BSA), FITC-biotin and fluorescein. The antibody fragment was obtained by selection from the n-CoDeR library (Söderlind et al., 2000).

Modelling of the binding site indicated that it is a cavity type binding site (Söderlind et al., 2000) and that there is a positively charged arginine residue within the cavity. The presence of an arginine residue is a feature often associated with FITC/fluorescein specific antibodies.

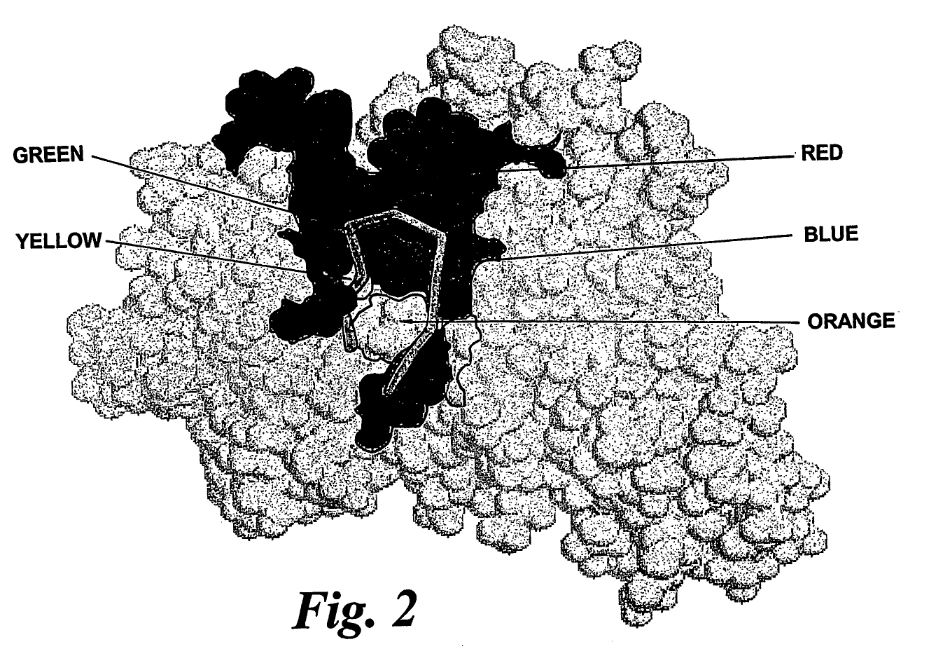

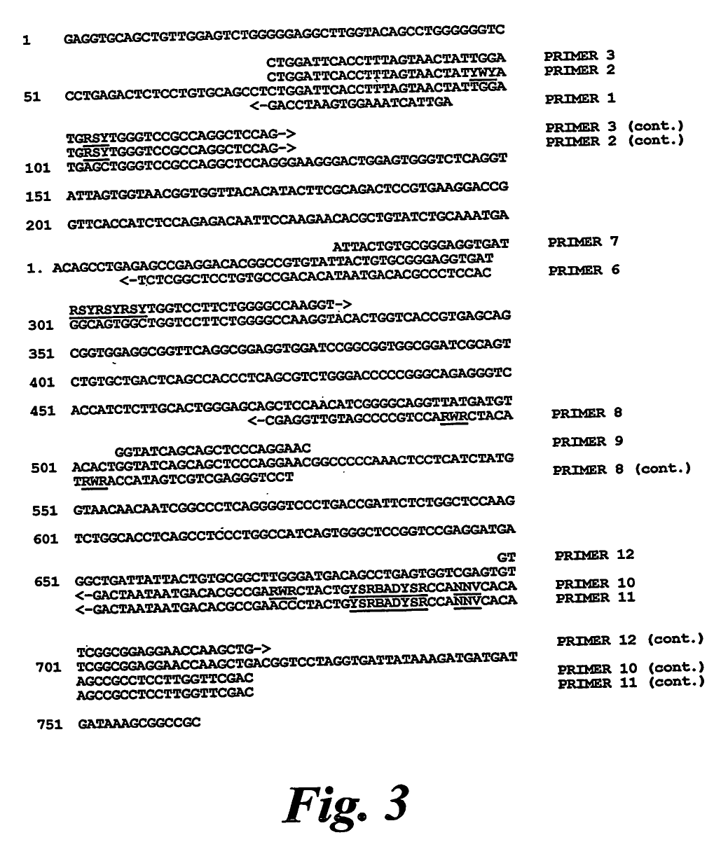

In addition to the arginine residue, the cavity is dominated by aromatic, aliphatic and hydroxyl-containing side chains (FIG. 2).

A strategy was devised to diversify the walls of the cavity with amino acids from the same physiochemical classification group as the original amino acid. The one exception was the arginine-containing residue typical for FITC/fluorescein specific antibodies, which in this case was left unaltered.

Nine residues in CDRH1, CDRL1 and CDRL3 were chosen for diversification. In addition three small residues at the tip of the relatively short CDH3 were diversified.

For the diversification process, oligonucleotide primers were designed and synthesised (Table 1). These primers were designed so as to replace a target amino acid with one from the same amino acid physiochemical classification group. For example, the tryptophan residues W33H and W91L (according to the Kabat numbering scheme, Kabat et al., 1991) could be replaced by another amino acid from the amino acids with a cyclic group i.e. tyrosine (Y), phenylalanine (F), histidine (H) or alternatively maintained as tryptophan (W) or replaced by leucine (L) based on similarities in volume and hydrophobicity (Goldsack et al., 1973). In the cases of W33H and W91L, two primers were made either to incorporate Y, F, H or L or to maintain W. The binding sites of these primers are shown in FIG. 3.

TABLE 1

Sequences of primers used to create an
initial cavity-type library. These primers
anneal to the original F8 template as
outlined in FIG. 3.

| | |
|---|---|
| Primer | Sequence |

| | |
|---|---|
| 1 | AGTTACTAAAGGTGAATCCAG |
| 2 | CTGGATTCACCTTTAGTAACTATYWYATGRSYTGGGTC |
| | GGCCAGGCTCCAG |
| 3 | CTGGATTCACCTTTAGTAACTATTGGATGRSYTGGGTCC |
| | GCCAGGCTCCAG |
| 6 | CACCTCCCGCACAGTAATACACAGCCGTGTCCTCGGCT |
| | CT |
| 7 | ATTACTGTGCGGGAGGTGATRSYRSYRSYTGGTCCTTCT |
| | GGGGCCAAGGT |
| 8 | TCCTGGGAGCTGCTGATACCARWRTACATCRWRACCT |
| | GCCCCGATGTTGGAGC |
| 9 | GGTATCAGCAGCTCCCAGGAAC |
| 10 | CAGCTTGGTTCCTCCGCCGAACACVNNACCRSYDABRS |
| | YGTCATCRWRAGCCGCACAGTAATAATCAG |
| 11 | CAGCTTGGTTCCTCCGCCGAACACVNNACCRSYDABRS |
| | YGTCATCCCAAGCCGCACAGTAATAATCAG |
| 12 | GTTCGGCGGAGGAACCAAGCTG |

The theoretical total diversity introduced in this example would be approximately 10⁸ different variants (not counting diversity incorporated by random mutations introduced by the PCR-based approach), the full extent of which could, but would not necessarily have to, be present in the library.

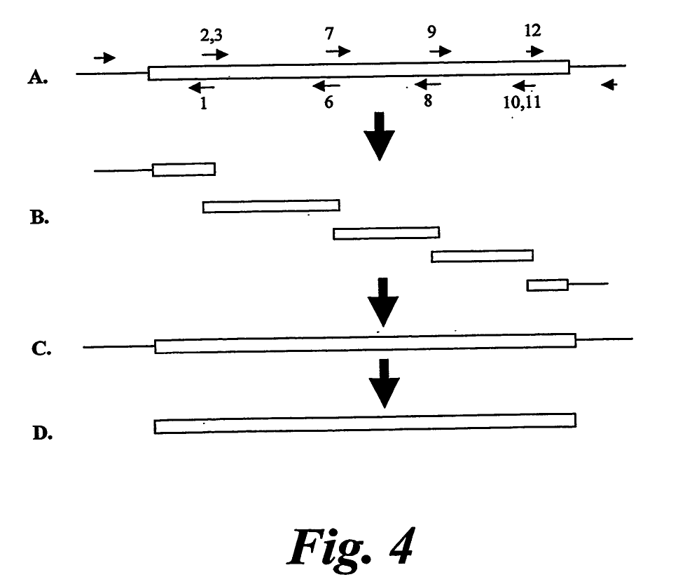

Fragments of the F8 gene, cloned into a phagemid vector from which gene 3 had been removed, were amplified using polymerase chain reaction (PCR) using the previously designed oligonucleotide primers to incorporate diversity into the relevant positions (FIG. 4).

The amplified gene fragments were purified by separation using gel electrophoresis. These purified, amplified fragments were mixed together and assembled into larger fragments. This assembly can occur in a single step or involve the assembly of intermediate-sized products in an intermediary step.

The assembled products were amplified using oligonucleotide primers that anneal to the 3′ and 5′ ends of the expected fully assembled product. If intermediate products are formed, then these are assembled into the final product which can then be amplified with primers annealing to the 3′ and 5′ end of the expected product.

The amplified fully assembled products are purified, cleaved with restriction enzymes and ligated into an appropriate vector for the production of the protein product as either a soluble protein or displayed on a surface (e.g. on a phage), as required.

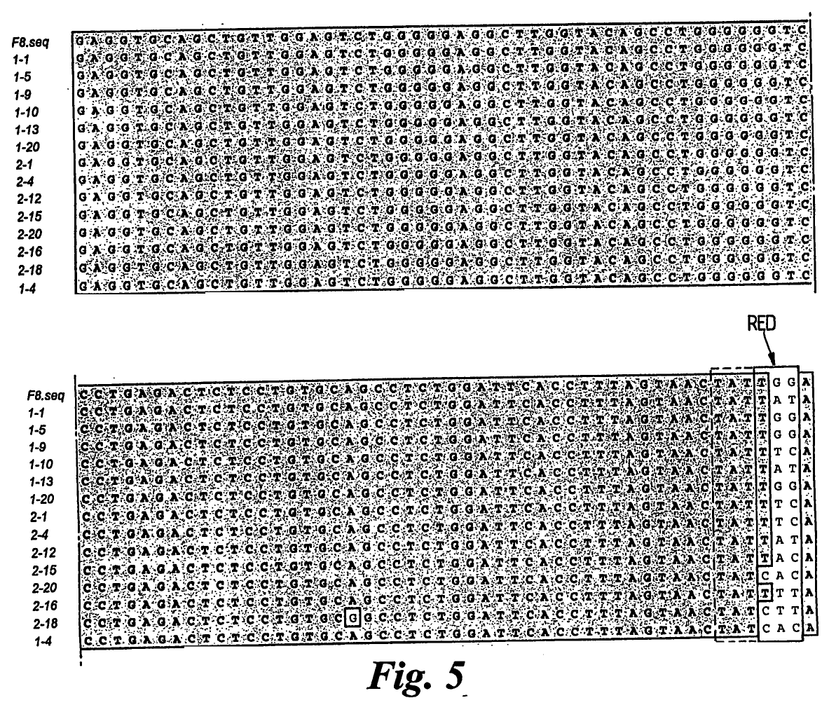

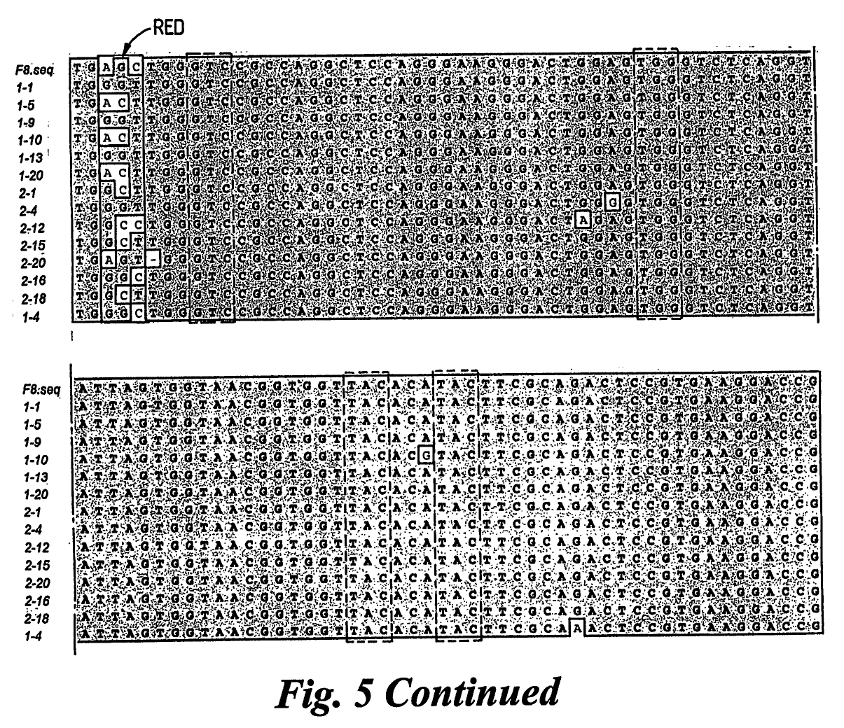

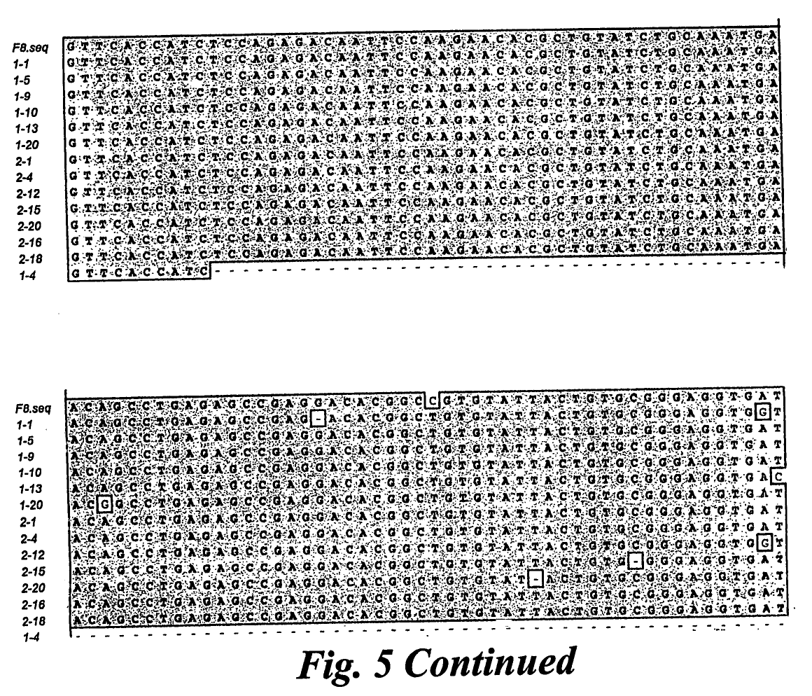

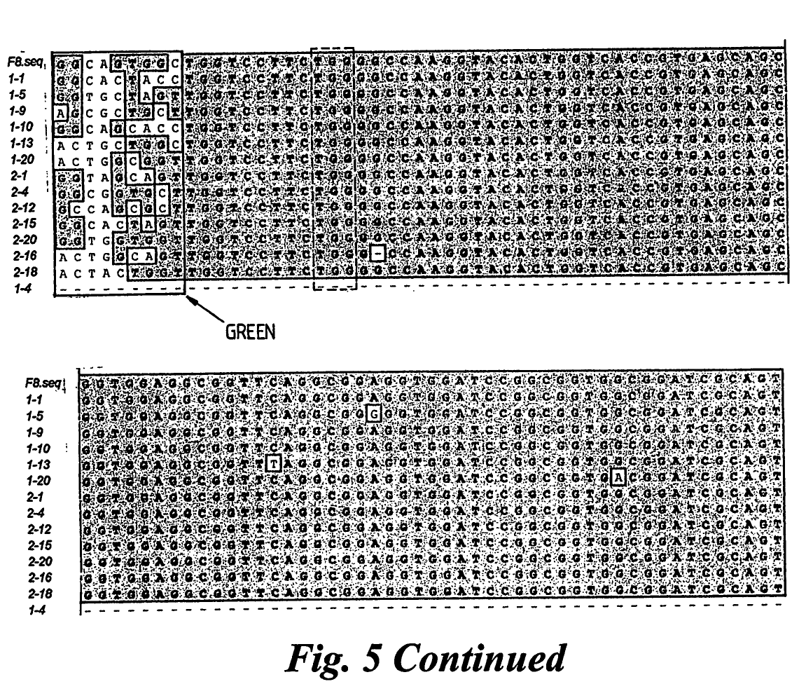

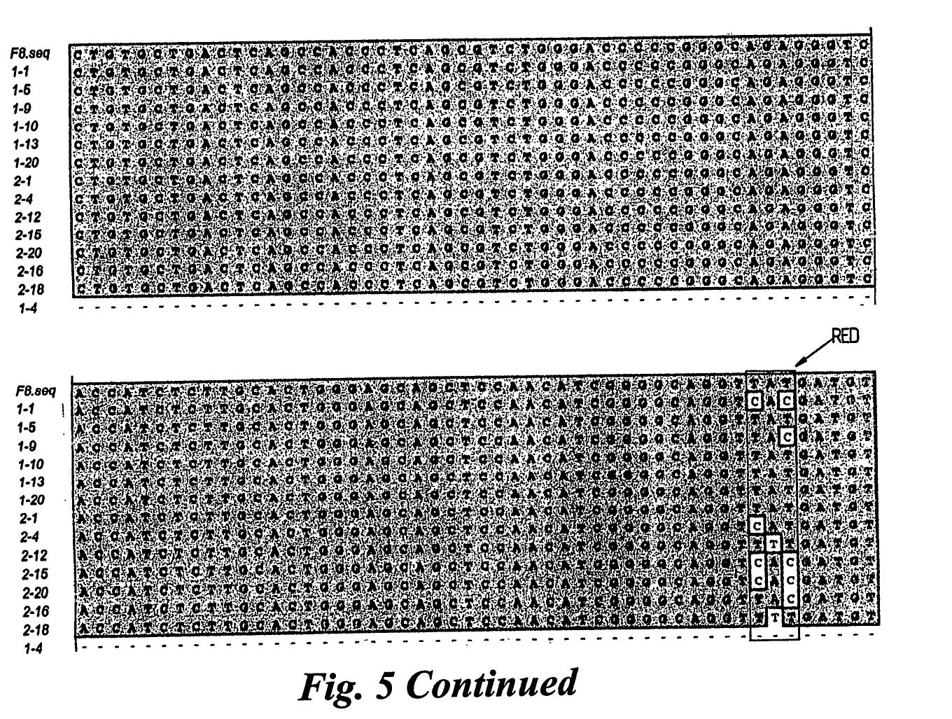

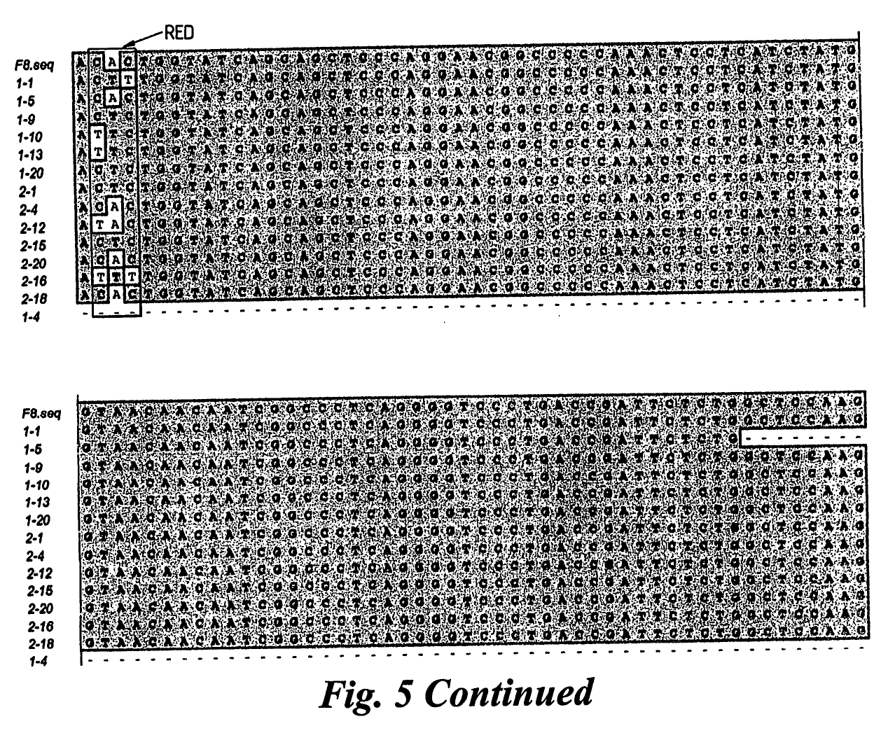

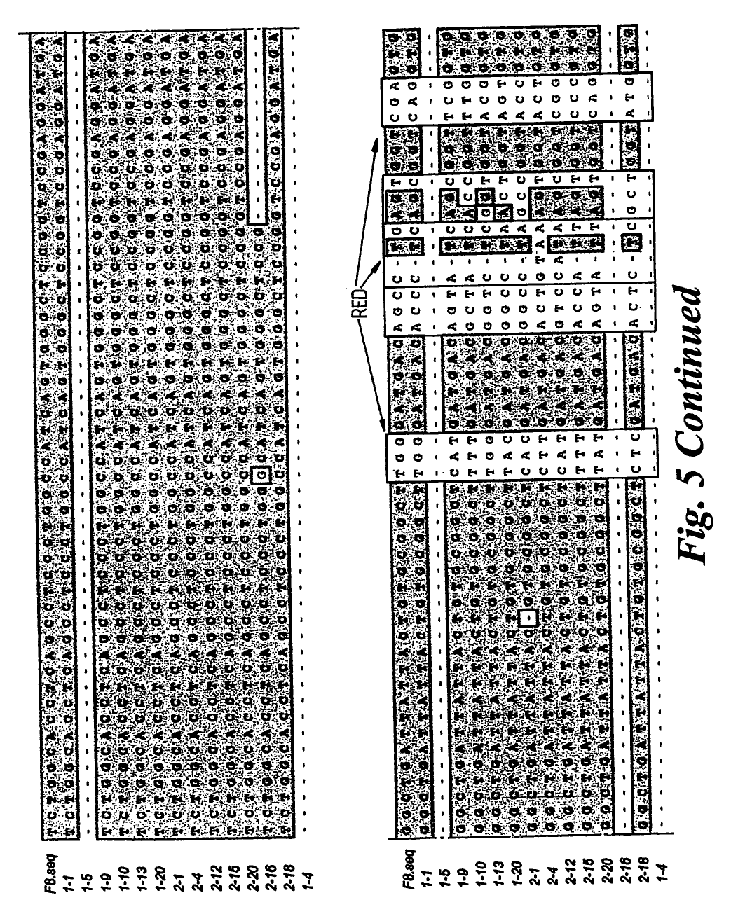

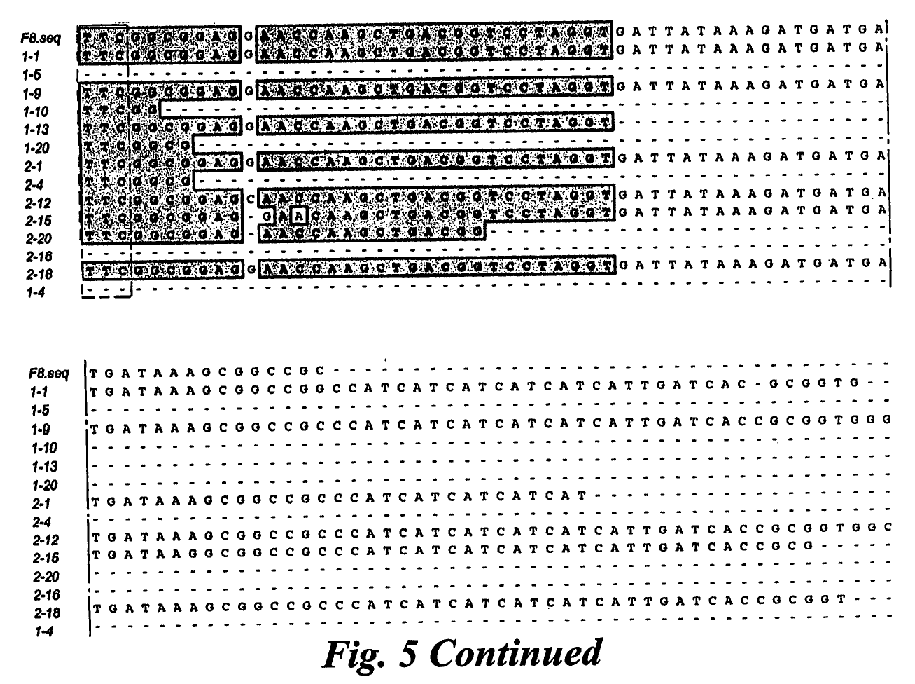

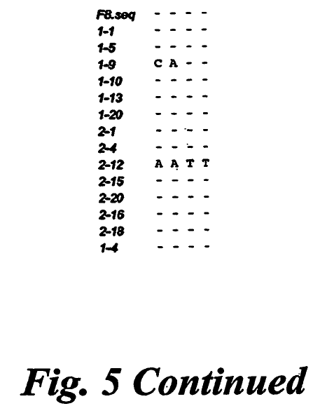

A set of assembled genes have been sequenced and shown to carry diversity in the expected positions after diversification, in addition to some random diversity probably incorporated as a consequence of polymerase errors or rare, random errors in the sequence of the primers (FIG. 5).

The diversity incorporated into the F8 scFv derived library may be further extended to other residues lining the cavity binding site, including (but not limited to) residues 32H, 37H, 47H, 56H, 58H, 103H, and 98L.

E. coli transformed with plasmids were grown in the presence of IPTG to induce production of recombinant antibody fragments. The bacteria had been transformed with plasmids encoding the F8 (FITC-specific scFv) or with plasmids (clone A-O) carrying randomly picked genes derived from a cavity-type library derived from directed mutagenesis of the F8 sequence.

Samples obtained from such cultures were added to ELISA plates coated with bovine serum albumin (BSA), FITC-BSA, testosterone 17β-hemisuccinate-BSA (testosterone-BSA), oestradiol-BSA (β-estradiol-6-oxime BSA) (Sigma-Aldrich, St. Louis, Mo., USA), 4-hydroxy-3-nitrophenylacetyl-BSA (NP-BSA) and azobenzene-arsonate-BSA (ABA-BSA) (Biosearch Technologies, Inc., Novato, Calif., USA).

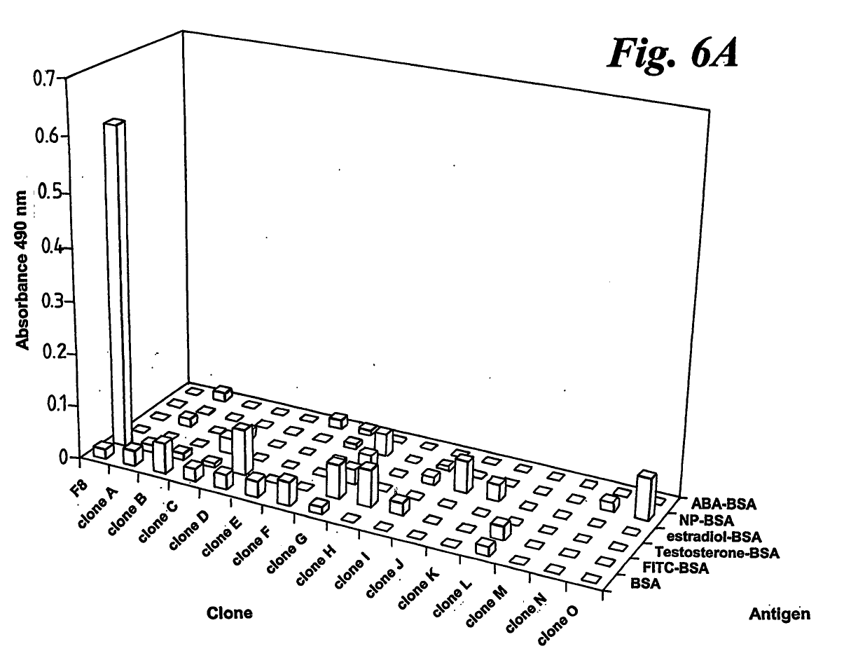

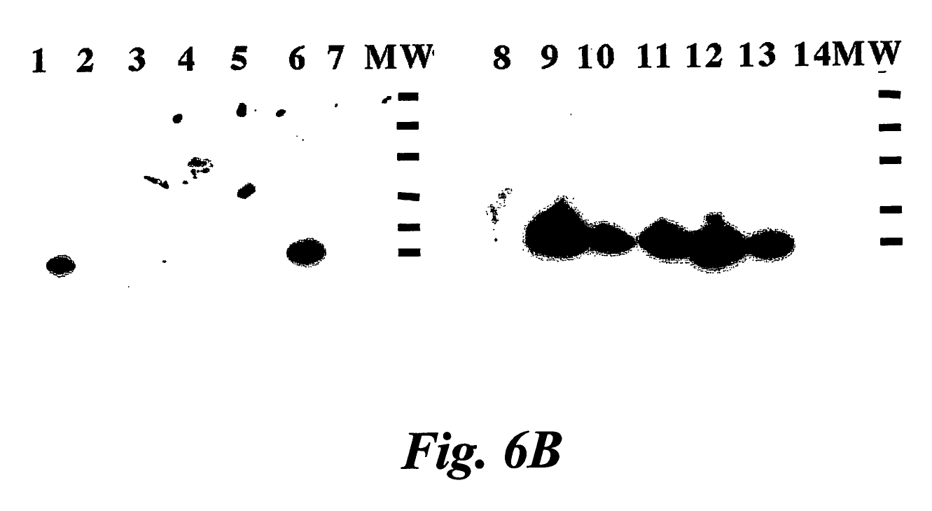

After binding, plates were washes and bound scFv was detected with mouse anti-FLAG M2 antibody (Sigma-Aldrich) and HRP-RAM-Ig (DAKO A/S, Glostrup, Denmark). Ortophenylenediamine (Sigma-Aldrich) was added together with H₂O₂ to visualise the reaction and 100 μl 1M H₂SO₄ was finally added in order to stop the reaction. The plates were subsequently analysed by absorbance measurements at 490 nm. Only F8 was able to recognise FITC-BSA and none of the clones recognised any of the other antigens (FIG. 6A).

Cell pellets obtained from 14 different, independently picked clones carrying a cavity-type scFv-encoding insert developed from the F8 sequence by mutagenesis were solubilised in a reducing cocktail.

The samples were boiled for 5 min and then run on a 12.5% SDS-PAGE gel using a Phast electrophoresis unit (PhastSystem RTM, Pharmacia Biotech, Uppsala, Sweden). After separation, the proteins were blotted onto a nitrocellulose membrane using the same unit. The membrane was blocked with PBS pH 7.4 (phosphate buffered saline) containing 1% fat-free milk.

To detect the proteins, the membrane was first incubated with mouse anti-FLAG M2 antibody (2.2 μg/ml) (Sigma-Aldrich) for one hour, followed by incubation with horseradish peroxidase (HRP) conjugated rabbit anti-mouse (RAM) immunoglobulins (DAKO) (diluted 1/2000) for one additional hour.

Washing steps were performed in PBS containing 0.05% Tween 20. The membranes were subsequently treated with the ECL plus kit (Amersham, Pharmacia Biotech UK Ltd., Amersham, UK) to visualize the blot when developing the film. The molecular weight standard (New England Biolabs) covers the range 83, 62, 48, 33, 25 kDa (from top to bottom). In this particular library construction 7/14 cloned genes expressed fill-length protein of the expected size (FIG. 6B).

### Example 2

### FITC8 Antibody Library Diversification

A small antibody library (2×10⁶ members) was created based on the principles described above. In total 14 residues within the proposed cavity were diversified as outlined in Table 2.

TABLE 2
Mutations introduced into the gene encoding the FITC8 to
create the library used in this example. Residues are numbered
consecutively starting from the first residue of VH FR1.
Standard one-letter codes for amino-acids are used.

| | Amino acid after | |
|---|---|---|
| Original amino acid | mutation | Antibody Region |
| W33 | H, L, Y, F, W | CDRH1 |
| S35 | S, T, G, A | CDRH1 |
| Y57 | H, L, Y, F | CDRH2 |
| Y59 | H, L, Y, F | CDRH2 |
| G101 | S, T, G, A | CDRH3 |
| S102 | S, T, G, A | CDRH3 |
| G103 | S, T, G, A | CDRH3 |
| H168 | H, L, Y, F | CDRL1 |
| Y165 | H, L, Y, F | CDRL1 |
| W225 | H, L, Y, F, W | CDRL3 |
| S228 | S, T, G, A | CDRL3 |
| L229 | L, V, I | CDRL3 |
| S230 | S, T, G, A | CDRL3 |
| R232 | H, L, Y, F | CDRL3 |

Antibody fragments were displayed on filamentous phage and selected with FITC-biotin and caught on streptavidin-coated paramagnetic beads. Alternatively the antibody fragments can be selected on NIP-BSA (4-hydroxy, 3-iodo, 5-nitrophenylacetyl conjugated to bovine serum albumin) that had been immobilised onto tosyl-activated paramagnetic beads (activated beads that are able to couple to molecules carrying a primary amino group and are available from Dynal A.S., Oslo, Norway).

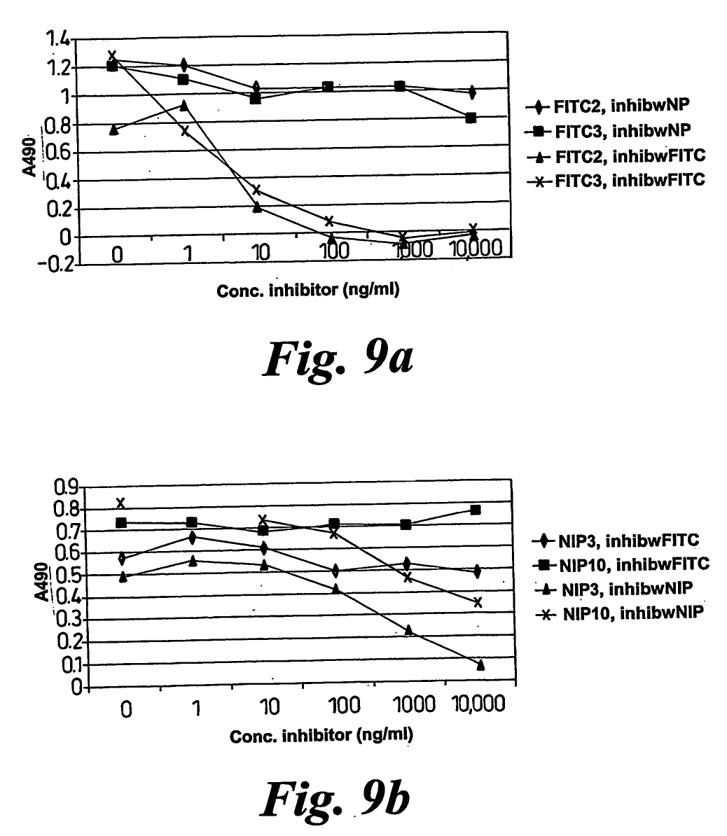

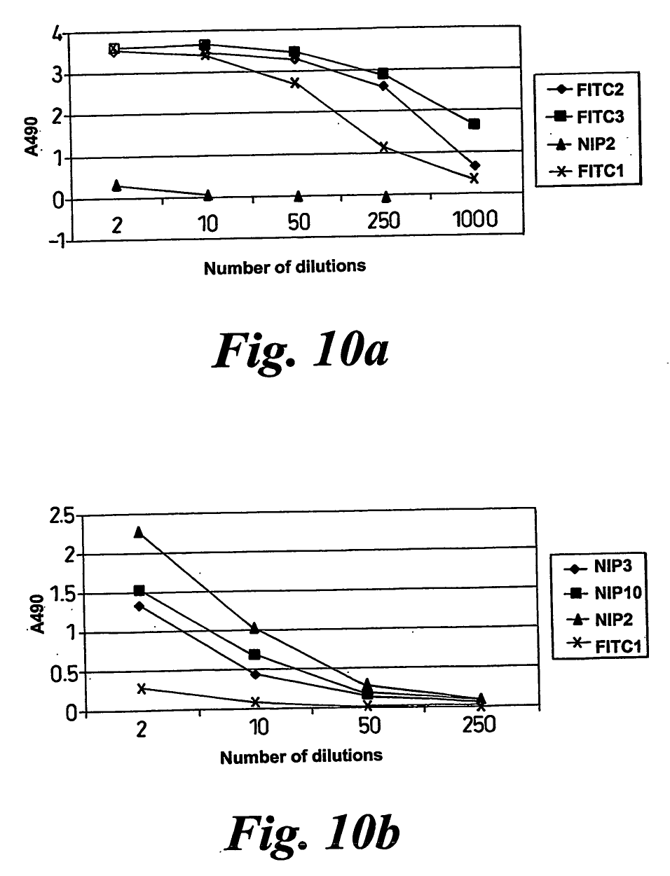

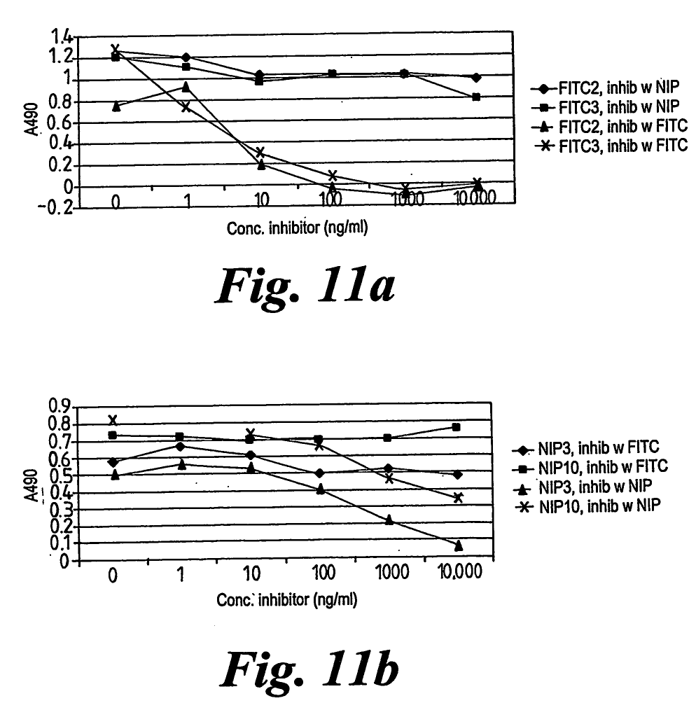

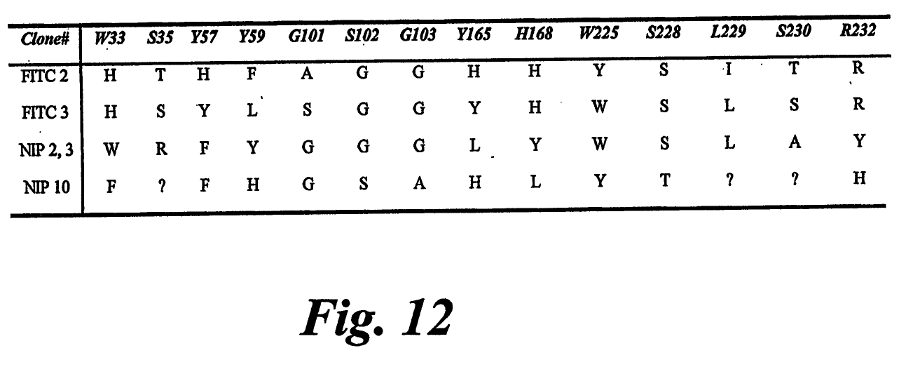

Individual clones were picked after 2-3 rounds of selection, expanded and used to prepare a monoclonal phage stock displaying scFv. The clones were assessed as follows:
1. ELISA for binding of phages displaying antibody fragments (½ dilution of phage-containing culture supernatant) to immobilised FITC-BSA, FITC-biotin-streptavidin, NIP-BSA, NP-BSA and BSA (coating at a protein concentration of 1 μg/ml).
This demonstrated that clones selected binding to FITC-BSA were specific for FITC. Similarly, phages selected for binding to NIP-BSA specifically bound this target and had a much-reduced recognition even of FITC-BSA (FIG. 9).
Binding was detected using an antibody specific for M13 protein 8 labelled with horse-radish peroxidase and the chromogen ortho-phenylenediamine.
2. Titration of the scFv-displaying phages bound to FITC-BSA and NIP-BSA demonstrated that the respective clones bound to their antigen in a concentration-dependent manner and reinforced the finding that the NIP-specific clone displayed a high degree of selectivity for NIP over FITC (FIG. 10).
3. Inhibition of binding of scFv-displaying phages by soluble protein-conjugated hapten in ELISA demonstrated that (a) scFv selected on NIP-BSA could be prevented from binding to its immobilised antigen by the addition of soluble NIP-BSA but not by FITC-BSA, and that (b) scFv selected on FITC-BSA could be prevented from binding to its immobilised antigen by soluble FITC-BSA but not by NIP-BSA (FIG. 11).
4. The genes encoding scFv selected on FITC-BSA and NIP-BSA were sequenced and carried modifications at some of the targeted residues (FIG. 12).

From this small library it was possible to select scFv-variants which specifically recognised the NIP hapten, unrelated to the FITC hapten recognised by the original scFv used to establish the library. This scFv displayed multiple distinct sequence differences as compared to the original FITC-specific scFv.

### Example 3

### Diversification of Other Antibodies

Any type of antibody variable domain sequence could form the basis for a library design of this type. The creation of libraries based on other antibodies with cavity binding sites, will require the targeting of residues other than those of F8 scFv identified in example 1, in order to achieve diversity in those residues that line the binding site.

Production of such a library would then involve structure determination and/or computer modelling of antibodies by methods such as (but not limited to) those taught by Whitelegg & Rees (2000), Mandal et al. (1996), Martin et al. (1991) and Sali et al. (1993), the disclosure of which in incorporated herein by reference.

Such structural determination and/or modelling can allow the identification of residues lining and/or in the immediate vicinity of a proposed cavity. Introduction of diversity into these positions can be achieved by any of a number of available techniques including, but not limited to, PCR using oligonucleotides to introduce diversity at the desired site.

### Example 4

### Diversification of Other Proteins with Cavity Binding Sites

Any protein with a cavity binding site could form the basis for a library design of this type and could be achieved by the methods of example 2. Examples of such proteins include hormone receptors; cytokine receptors; cellular receptors for viral proteins; T cell receptors and other proteins known to persons skilled in the art.

### Example 5

### Diversification by Incorporating Natural Diversity

Apart from incorporating diversity into the library by using synthetic oligonucleotides, natural diversity can be incorporated into the library with an approach similar to CDR-shuffling such as described by Jirholt et al., (1998); Söderlind et al., (2000).

Natural CDRH3 diversity can be amplified by PCR using oligonucleotide primers designed to be complementary to regions adjacent to the CDR. Subsequently, the amplified CDRH3 sequences can be purified by chromatography methods such as (but not limited to) ion exchange HPLC or size exclusion HPLC.

The purified CDRH3 sequences can then be used as a source of natural, functional diversity that can be inserted into the gene construct and be expected to produce a short CDRH3 loop that will contribute a portion of the wall of the cavity binding site.

Similarly, natural diversity in other loops can be amplified by the above method. Additionally, primers can be designed so as to fit only genes appropriate for the target cavity binding site. For example, the CDRH2 sequence in the scFv F8 originates from antibody DP47. Primers can be designed to amplify the entire or parts of the hypervariable loop originating from DP47, thus amplifying only that CDR region.

Where necessary, amplification can be performed by nested PCR as a first step in order to better define the gene according to its origin, while the specific diversity is introduced and amplified as a second PCR reaction.

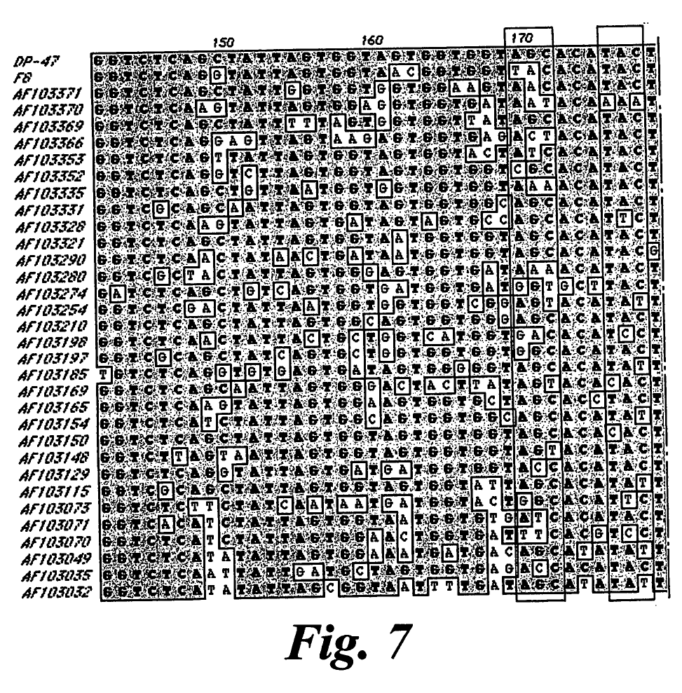

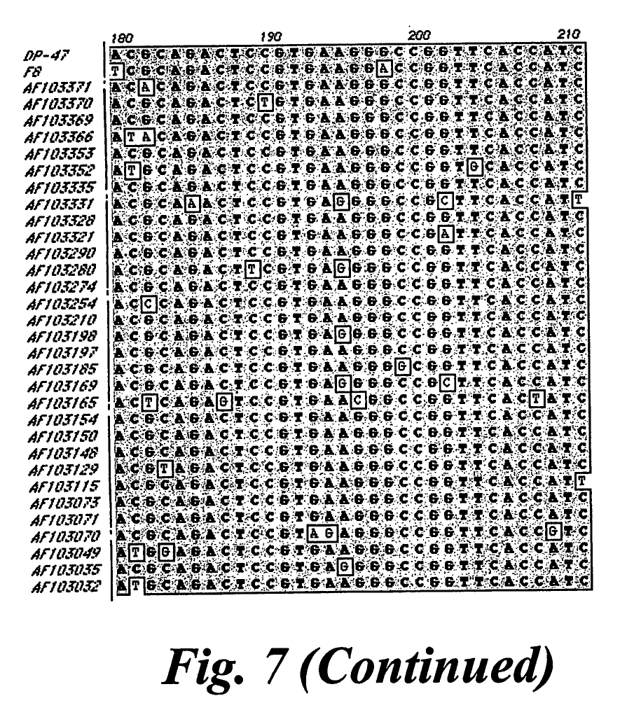

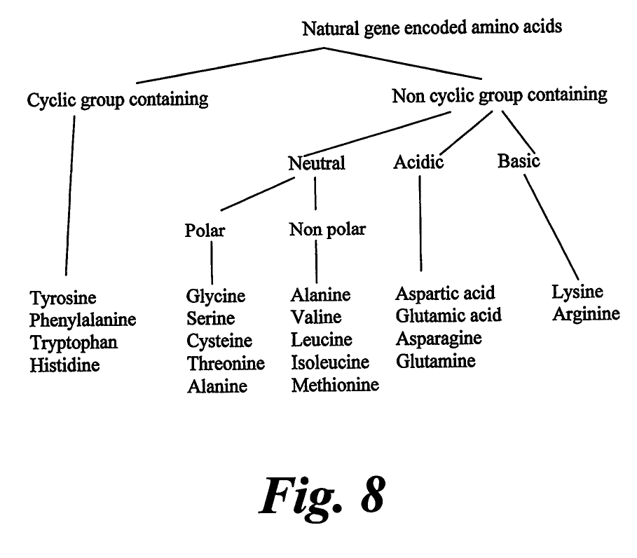

The cDNA template would typically, but not necessarily, be enriched for sequences derived from isotype switched genes (IgG, IgE or IgA) by performing cDNA synthesis using isotype-specific primers. This can also increase the amount of diversity. The type and level of diversity expected from such an approach would be similar to that that found in natural IgG repertoires, examples of which are found in FIG. 7.

### Example 6

### Selection of Anti-Ligands

A cavity binding site library could be screened for specific anti-ligands by any of the currently available techniques for selection. These include, but are not limited to, selection of ligand specific clones on:
1. Immobilised ligand on a solid support, e.g. a plastic surface or a chromatography matrix
2. Streptavidin coated beads, e.g. paramagnetic beads, in conjunction with biotinylated ligand, as described by Hawkins et al. (1992). In this case the library can, but necessarily have to, be pre-incubated with the biotinylated ligand prior to addition of the streptavidin beads
3. Immobilised ligand carrying a tag-sequence for which specific anti-ligands exist, for example the myc peptide as taught by Hoogenboom et al. (1991). Particles displaying specific anti-ligands will be selectively retrieved by being bound to the solid support through the tag-labelled ligand, while non-binding particles do not bind and are washed away.
4. Flow systems that separate binding clones based on dissociation rate, Malmborg et al., and (1996).

Selection can be performed in one or more steps as deemed appropriate.

The selection step can also include further steps whereby the incorporation of ligand subsequent to the initial binding phase is used to select for high affinity anti-ligands or slowly dissociating anti-ligands as taught by Hawkins et al., (1992).

### Example 7

### Further Evolution of Anti-Ligands

Specific anti-ligands derived from these cavity binding site libraries may be used as a starting point for further evolution in order to improve the binding characteristics of the anti-ligands to enhance or better correlate to their final use.

Such evolution may involve, but is not limited to, CDR shuffling (Jirholt et al., 2001), random mutagenesis (Cadwell R C and Joyce, 1994; Low et al., 1996) or targeted mutagenesis using degenerate oligonucleotide primers.

### REFERENCES (THE DISCLOSURE OF WHICH IS INCORPORATED HEREIN)

Barbas C F, Amberg A, Simoncsits A, Jones T M and Lerner R A (1993) Selection of human anti-hapten antibodies from semisynthetic libraries, Gene, 137, 57-62

Bigelow C C (1967) On the average hydrophobicity of proteins and the relation between it and protein structure. J. Theor. Biol. 16, 187-211.

Cadwell R C, Joyce G F (1994) Mutagenic PCR. PCR Methods Appl. 3, S136-140.

Chames P, Coulon S and Baty D (1998) Improving the affinity and the fine specificity of an anti-cortisol antibody by parsimonious mutagenesis and phage display, J. Immunol., 161, 5421-5429

Daugherty P S, Chen G, Iverson B L and Georgiou G (2000) Quantative analysis of the effect of the mutation frequency on the affinity maturation of single chain Fv antibodies, Proc. Natl. Acad. Sci. 97, 2029-2034

de Wildt R M T, Hoet R M A, van Venrooij W J, Tomlinson I M, Winter G (1999) Analysis of heavy and light chain pairings indicates that receptor editing shapes the human antibody repertoire. J Mol. Biol. 285, 895-901.

Faber C, Shan L, Fan Z, Guddat L W, Furebring C, Ohlin M, Borrebaeck C A K, Edmundson A B (1998) Three-dimensional structure of a human Fab with high affinity for tetanus toxoid. Immunotechnology, 3, 253-270

Fauchere, J. L., Charton, M., Kier, L. B., Verloop, A. and Pliska, V. (1988) Amino acid side chain parameters for correlation studies in biology and pharmacology. Int. J. Peptide protein Res., 32, 269-278.

Goldsack D E and Chalifoux R C (1973) Contribution of the free-energy of mixing hydrophobic side chains to the stability of the tertiary structure. J. Theor. Biol. 39, 645-651

Hanes J, Plückthun A (1997) In vitro selection and evolution of functional proteins by using ribosome display. Proc. Natl. Acad. Sci. USA 94, 4937-4942.

Hawkins R E, Russell S J, Winter G (1992) Selection of phage antibodies by binding affinity. Mimicking affinity maturation. J Mol Biol 226, 889-896.

Herron J N, He X M, Mason M L, Voss E W Jr, Edmundson A B (1989) Three-dimensional structure of a fluorescein-Fab complex crystallized in 2-methyl-2,4-pentanediol. Proteins 5, 271-280.

Hoogenboom H R, Griffiths A D, Johnson K S, Chiswell D J, Hudson P, Winter G (1991) Multi-subunit proteins on the surface of filamentous phage: methodologies for displaying antibody (Fab) heavy and light chains. Nucleic Acids Res 19, 4133-4137.

Jeffrey P D, Strong R K, Sieker L C, Chang C Y, Campbell R L, Petsko G A, Haber E, Margolies M N, Sheriff, S (1993) 26-10 Fab-digoxin complex: affinity and specificity due to surface complementarity. Proc Natl Acad Sci USA 90, 10310

Jirholt P, Ohlin M, Borrebaeck C A K, Söderlind E (1998) Exploiting sequence space: shuffling in vivo formed complementarity determining regions into a master framework. Gene 215, 471-476.

Jirholt P, Strandberg L, Jansson B, Krambovitis E, Soderlind E, Borrebaeck C A K, Carlsson R, Danielsson L, Ohlin M (2001) A central core structure in an antibody variable domain determines antigen specificity. Protein Eng 14, 67-74.

Kabat E A et al. (1991) Sequences of Proteins of Immunological Interest, NIH Publication 91-3242.

Kirkham P M, Neri D, Winter G (1999) Towards the design of an antibody that recognises a given protein epitope. J Mol Biol 285, 909-915.

Krykbaev R A, Liu, W R, Jeffrey P D and Margolies M N (2001) Phage Display-selected sequences of the heavy-chain CDR3 Loop of the Anti-digoxin Antibody 26-10 define a high affinity binding site for position 16-substituted analogs of digoxin, J. Biol. Chem., 276, 8149-8158

Lamminmäki, U, Pauperio S, Westerlund-Karlsson A, Karvinene J, Virtanen P L, Lovgren T and Saviranta P (1999) Expanding the conformational diversity by random insertions to CDRH2 results in improved anti-estradiol antibodies, J. Mol. Biol., 21, 589-602.

Lamminmäki, U, Kankare, J A (2001) Crystal Structure of a Recombinant Anti-Estradiol Fab Fragment in Complex with 17β-Estradiol. J Biol Chem 276, 36687.

Low N M, Holliger P H, Winter G (1996) Mimicking somatic hypermutation: affinity maturation of antibodies displayed on bacteriophage using a bacterial mutator strain. J. Mol. Biol. 260,359-368.

MacCallum R M, Martin A C, Thornton J M (1996) Antibody-antigen interactions: contact analysis and binding site topography. J Mol Biol 262, 732-745.

Malmborg A C, Duenas M, Ohlin M, Soderlind E, Borrebaeck C A K (1996) Selection of binders from phage displayed antibody libraries using the BIAcore biosensor. J Immunol Methods 198, 51-57.

Mandal C, Kingery B D, Anchin J M, Subramaniam S and Linthicum D S (1996) ABGEN: a knowledge-based automated approach for antibody structire modelling. Nature Biotechnology 14, 323-328

Martin A C R, Cheetham J C and Rees A R (1991) Molecular modelling of antibody combining sites. Meth. Enz. 203, 121-153

Mattheakis L C, Bhatt R R, Dower W J (1994) An in vitro polysome display system for identifying ligands from very large peptide libraries. Proc Natl Acad Sci USA 91, 9022-9026.

Sali A, Blundell T L (1993) Comparative protein modeling by satisfaction of spatial restraints. J Mol Biol 234, 779-815

Simon T, Henrick K, Hirshberg M, Winter G (1998) X-Ray Structures of Fv Fragment and its (4-Hydroxy-3-Nitrophenyl)Acetate Complex of Murine B1-8 Antibody. (information available at http://www.pdb.org).

Smith G P (1985) Filamentous fusion phage: novel expression vectors that display cloned antigens on the virion surface. Science 228, 1315-1317.

Söderlind E, Strandberg L, Jirholt P, Kobayashi N, Alexeiva V, Åberg A M, Nilsson A, Jansson B, Ohlin M, Wingren C, Danielsson L, Carlsson R, Borrebaeck C A K (2000) Recombining germline-derived CDR sequences for creating diverse single-framework antibody libraries. Nat Biotechnol 18, 852-856.

Söderlind E, Carlsson R, Borrebaeck C A K, Ohlin M (2001) The immune diversity in a test tube--non-immunised antibody libraries and functional variability in defined protein scaffolds. Comb Chem High Throughput Screen 4,409-416.

Whitelegg N R, Rees A R (2000) WAM: an improved algorithim for modelling antibodies on the WEB. Protein Eng 13 819-824

1-19. (canceled)

20. A method of making a library of anti-ligands having a cavity binding site for a ligand the method comprising:
deriving a plurality of anti-ligands from a first anti-ligand having a cavity for binding a first ligand and differing from the first anti-ligand in that one or more of the amino acid residues of the anti-ligands which make up the ligand binding surface of the cavity are varied,
whereby the plurality of anti-ligands have a binding affinity for the first ligand which is different from that of the first anti-ligand, and
wherein the one or more amino acid residues which is varied, is varied by replacement with one amino acid having similar but different physicochemical properties to the one or more amino acid residues, and wherein the one or more amino acids being varied can be varied to become a different amino acid in each anti-ligand molecule being varied.

21. The method of claim 20, wherein the similar but different physicochemical properties are selected from at least one of charge, hydrophobicity/hydrophilicity, size and structure.

22. The method of claim 20, wherein the amino acids having similar but different physiochemical properties are selected from the group consisting of cyclic amino acids and non-cyclic acidic amino acids, with the proviso that proline is not a cyclic amino acid.

23. The method of claim 22, wherein the cyclic amino acid group is selected from the group consisting of phenylalanine, tyrosine, tryptophan and histidine.

24. The method of claim 22, wherein the non-cyclic acidic amino acid group is selected from the group consisting of aspartic acid, glutamic acid, asparagine and glutamine.

25. The method of claim 22, wherein the amino acid is a non-cyclic basic amino acids.

26. The method of claim 25, wherein the non-cyclic basic amino acid group is slected from the group consisting of lysine and arginine.

27. The method of claim 22, wherein the amino acid is selected from neutral non-cyclic non-polar amino acids and neutral non-cyclic polar amino acids.

28. The method of claim 27, wherein the non-cyclic neutral polar amino acid group is selected from the group consisting of glycine, serine, cystine and threonin.

29. The method of claim 27, wherein the non-cyclic neutral non-polar amino acid group is selected from the group consisting of alanine, valine, isoleucine, leucine and methionine.

30. The method of claim 20, wherein the ligand is a low molecular weight compound which is capable of full or partial insertion into a cavity binding site of one or more of the anti-ligands, wherein the low molecular weight compound has a molecular weight of 100 to 3000 Da.

31. The method of claim 20, wherein the ligand is a protrusion of a larger compound, which protrusion is capable of full or partial insertion into a cavity binding site of one or more of the anti-ligands.

32. The method of claim 31, wherein the protrusion is a proteinaceous loop.

33. The method of claim 31, where the protrusion is a non-peptide.

34. The method of claim 33, wherein the protrusion is a carbohydrate or a lipid.

35. The method of claim 20, wherein the ligand is at least one of steroids, carbohydrates, peptides, vitamins, lipids, aromatic compounds, aliphatic compounds, organic acids, organic bases, organic esters, organic amides, organic amines, organic ketones, organic aldehydes, organic alcohols, organometallic compounds, heterocyclic compounds or sulphur-containing compounds.

36. The method of claim 20, wherein the anti-ligand is an antibody or a fragment thereof which is capable of forming a cavity type binding site.

37. The method of claim 36, wherein the ligand is an antigen.

38. The method of claim 37, wherein the ligand is a hapten.

39. The method of claim 20, wherein the one or more amino acids are varied by replacement with amino acids derived from the equivalent amino acid position from a natural CDR which make up the cavity binding site of an antibody molecule.

40. The method of claim 39, wherein the ligand is an antigen.

41. The method of claim 40, wherein the ligand is a hapten.

42. A library of anti-ligands having a cavity binding site for one or more ligands, wherein the library is prepared by the process of claim 20.

43. A method for obtaining an anti-ligand for a ligand comprising screening the library of claim 42 against the ligand.


SEQUENCE LISTING (58 sequences)

SEQ ID NO: 1 - DNA, 21 bp, Artificial Sequence
  Primer annealing to F8 template
agttactaaaggtgaatccag

SEQ ID NO: 2 - DNA, 51 bp, Artificial Sequence
  Primer annealing to F8 template
ctggattcacctttagtaactatywyatgrsytgggtccgccaggctccag

SEQ ID NO: 3 - DNA, 51 bp, Artificial Sequence
  Primer annealing to F8 template
ctggattcacctttagtaactattggatgrsytgggtccgccaggctccag

SEQ ID NO: 4 - DNA, 40 bp, Artificial Sequence
  Primer annealing to F8 template
cacctcccgcacagtaatacacagccgtgtcctcggctct

SEQ ID NO: 5 - DNA, 50 bp, Artificial Sequence
  Primer annealing to F8 template
attactgtgcgggaggtgatrsyrsyrsytggtccttctggggccaaggt

SEQ ID NO: 6 - DNA, 53 bp, Artificial Sequence
  Primer annealing to F8 template
tcctgggagctgctgataccarwrtacatcrwracctgccccgatgttggagc

SEQ ID NO: 7 - DNA, 22 bp, Artificial Sequence
  Primer annealing to F8 template
ggtatcagcagctcccaggaac

SEQ ID NO: 8 - DNA, 68 bp, Artificial Sequence
  Primer annealing to F8 template
cagcttggttcctccgccgaacacvnnaccrsydabrsygtcatcrwragccgcacagtaataatcag

SEQ ID NO: 9 - DNA, 68 bp, Artificial Sequence
  Primer annealing to F8 template
cagcttggttcctccgccgaacacvnnaccrsydabrsygtcatcccaagccgcacagtaataatcag

SEQ ID NO: 10 - DNA, 22 bp, Artificial Sequence
  Primer annealing to F8 template
gttcggcggaggaaccaagctg

SEQ ID NO: 11 - DNA, 764 bp, Artificial Sequence
  F8 ScFv binding site (template DNA)
gaggtgcagctgttggagtctgggggaggcttggtacagcctggggggtccctgagactctcctgtgcagcctctggattcacctttagtaactattggatgagctgggtccgccaggctccagggaagggactggagtgggtctcaggtattagtggtaacggtggttacacatacttcgcagactccgtgaaggaccggttcaccatctccagagacaattccaagaacacgctgtatctgcaaatgaacagcctgagagccgaggacacggccgtgtattactgtgcgggaggtgatggcagtggctggtccttctggggccaaggtacactggtcaccgtgagcagcggtggaggcggttcaggcggaggtggatccggcggtggcggatcgcagtctgtgctgactcagccaccctcagcgtctgggacccccgggcagagggtcaccatctcttgcactgggagcagctccaacatcggggcaggttatgatgtacactggtatcagcagctcccaggaacggcccccaaactcctcatctatggtaacaacaatcggccctcaggggtccctgaccgattctctggctccaagtctggcacctcagcctccctggccatcagtgggctccggtccgaggatgaggctgattattactgtgcggcttgggatgacagcctgagtggtcgagtgttcggcggaggaaccaagctgacggtcctaggtgattataaagatgatgatgataaagcggccgc

SEQ ID NO: 12 - DNA, 795 bp, Artificial Sequence
  F8 mutated clone 1-1
gaggtgcagctgttggagtctgggggaggcttggtacagcctggggggtccctgagactctcctgtgcagcctctggattcacctttagtaactattatatgggttgggtccgccaggctccagggaagggactggagtgggtctcaggtattagtggtaacggtggttacacatacttcgcagactccgtgaaggaccggttcaccatctccagagacaattccaagaacacgctgtatctgcaaatgaacagcctgagagccgagacacggccgtgtattactgtgcgggaggtggtggcactacctggtccttctggggccaaggtacactggtcaccgtgagcagcggtggaggcggttcaggcggaggtggatccggcggtggcggatcgcagtctgtgctgactcagccaccctcagcgtctgggacccccgggcagagggtcaccatctcttgcactgggagcagctccaacatcggggcaggtcacgatgtactttggtatcagcagctcccaggaacggcccccaaactcctcatctatggtaacaacaatcggccctcaggggtccctgaccgattctctggctccaagtctggcacctcagcctccctggccatcagtgggctccggtccgaggatgaggctgattattactgtgcggcttgggatgacaccctcagcggtcaggtgttcggcggaggaaccaagctgacggtcctaggtgattataaagatgatgatgataaagcggccggccatcatcatcatcatcattgatcacgcggtg

SEQ ID NO: 13 - DNA, 592 bp, Artificial Sequence
  F8 mutated clone 1-5
gaggtgcagctgttggagtctgggggaggcttggtacagcctggggggtccctgagactctcctgtgcagcctctggattcacctttagtaactattggatgacttgggtccgccaggctccagggaagggactggagtgggtctcaggtattagtggtaacggtggttacacatacttcgcagactccgtgaaggaccggttcaccatctccagagacaattccaagaacacgctgtatctgcaaatgaacagcctgagagccgaggacacggccgtgtattactgtgcgggaggtgatggtgctagctggtccttctggggccaaggtacactggtcaccgtgagcagcggtggaggcggttcaggcgggggtggatccggcggtggcggatcgcagtctgtgctgactcagccaccctcagcgtctgggacccccgggcagagggtcaccatctcttgcactgggagcagctccaacatcggggcaggttatgatgtacactggtatcagcagctcccaggaacggcccccaaactcctcatctatggtaacaacaatcggccctcaggggtccctgaccgattctctg

SEQ ID NO: 14 - DNA, 801 bp, Artificial Sequence
  F8 mutated clone 1-9
gaggtgcagctgttggagtctgggggaggcttggtacagcctggggggtccctgagactctcctgtgcagcctctggattcacctttagtaactattggatgagctgggtccgccaggctccagggaagggactggagtgggtctcaggtattagtggtaacggtggttacacatacttcgcagactccgtgaaggaccggttcaccatctccagagacaattccaagaacacgctgtatctgcaaatgaacagcctgagagccgaggacacggccgtgtattactgtgcgggaggtgatagcgctgcttggtccttctggggccaaggtacactggtcaccgtgagcagcggtggaggcggttcaggcggaggtggatccggcggtggcggatcgcagtctgtgctgactcagccaccctcagcgtctgggacccccgggcagagggtcaccatctcttgcactgggagcagctccaacatcggggcaggttacgatgtacactggtatcagcagctcccaggaacggcccccaaactcctcatctatggtaacaacaatcggccctcaggggtccctgaccgattctctggctccaagtctggcacctcagcctccctggccatcagtgggctccggtccgaggatgaggctgattattactgtgcggctcatgatgacagtatcagcggttcggtgttcggcggaggaaccaagctgacggtcctaggtgattataaagatgatgatgataaagcggccgcccatcatcatcatcatcattgatcaccgcggtgggca

SEQ ID NO: 15 - DNA, 704 bp, Artificial Sequence
  F8 mutated clone 1-10
gaggtgcagctgttggagtctgggggaggcttggtacagcctggggggtccctgagactctcctgtgcagcctctggattcacctttagtaactatttcatgacttgggtccgccaggctccagggaagggactggagtgggtctcaggtattagtggtaacggtggttacacgtacttcgcagactccgtgaaggaccggttcaccatctccagagacaattccaagaacacgctgtatctgcaaatgaacagcctgagagccgaggacacggccgtgtattactgtgcgggaggtgatggcagcacctggtccttctggggccaaggtacactggtcaccgtgagcagcggtggaggcggttcaggcggaggtggatccggcggtggcggatcgcagtctgtgctgactcagccaccctcagcgtctgggacccccgggcagagggtcaccatctcttgcactgggagcagctccaacatcggggcaggttatgatgtatactggtatcagcagctcccaggaacggcccccaaactcctcatctatggtaacaacaatcggccctcaggggtccctgaccgattctctggctccaagtctggcacctcagcctccctggccatcagtgggctccggtccgaggatgaggctgattattactgtgcggcttttgatgacgctatcaccggtttggtgttcgg

SEQ ID NO: 16 - DNA, 732 bp, Artificial Sequence
  F8 mutated clone 1-13
gaggtgcagctgttggagtctgggggaggcttggtacagcctggggggtccctgagactctcctgtgcagcctctggattcacctttagtaactattatatgagctgggtccgccaggctccagggaagggactggagtgggtctcaggtattagtggtaacggtggttacacatacttcgcagactccgtgaaggaccggttcaccatctccagagacaattccaagaacacgctgtatctgcaaatgaacagcctgagagccgaggacacggccgtgtattactgtgcgggaggtgacactgctggctggtccttctggggccaaggtacactggtcaccgtgagcagcggtggaggcggtttaggcggaggtggatccggcggtggcggatcgcagtctgtgctgactcagccaccctcagcgtctgggacccccgggcagagggtcaccatctcttgcactgggagcagctccaacatcggggcaggttatgatgtatactggtatcagcagctcccaggaacggcccccaaactcctcatctatggtaacaacaatcggccctcaggggtccctgaccgattctctggctccaagtctggcacctcagcctccctggccatcagtgggctccggtccgaggatgaggctgattattactgtgcggcttgggatgacggtctcggtggtacggtgttcggcggaggaaccaagctgacggtcctaggt

SEQ ID NO: 17 - DNA, 706 bp, Artificial Sequence
  F8 mutated clone 1-20
gaggtgcagctgttggagtctgggggaggcttggtacagcctggggggtccctgagactctcctgtgcagcctctggattcacctttagtaactattggatgacctgggtccgccaggctccagggaagggactggagtgggtctcaggtattagtggtaacggtggttacacatacttcgcagactccgtgaaggaccggttcaccatctccagagacaattccaagaacacgctgtatctgcaaatgaacggcctgagagccgaggacacggccgtgtattactgtgcgggaggtgatactggcggttggtccttctggggccaaggtacactggtcaccgtgagcagcggtggaggcggttcaggcggaggtggatccggcggtgacggatcgcagtctgtgctgactcagccaccctcagcgtctgggacccccgggcagagggtcaccatctcttgcactgggagcagctccaacatcggggcaggttatgatgtacactggtatcagcagctcccaggaacggcccccaaactcctcatctatggtaacaacaatcggccctcaggggtccctgaccgattctctggctccaagtctggcacctcagcctccctggccatcagtgggctccggtccgaggatgaggctgattattactgtgcggcttacgatgacggcctaactggtagtgtgttcggcg

SEQ ID NO: 18 - DNA, 779 bp, Artificial Sequence
  F8 mutated clone 2-1
gaggtgcagctgttggagtctgggggaggcttggtacagcctggggggtccctgagactctcctgtgcagcctctggattcacctttagtaactatttcatggcttgggtccgccaggctccagggaagggactggagtgggtctcaggtattagtggtaacggtggttacacatacttcgcagactccgtgaaggaccggttcaccatctccagagacaattccaagaacacgctgtatctgcaaatgaacagcctgagagccgaggacacggccgtgtattactgtgcgggaggtgatggtagcagttggtccttctggggccaaggtacactggtcaccgtgagcagcggtggaggcggttcaggcggaggtggatccggcggtggcggatcgcagtctgtgctgactcagccaccctcagcgtctgggacccccgggcagagggtcaccatctcttgcactgggagcagctccaacatcggggcaggttatgatgtacactggtatcagcagctcccaggaacggcccccaaactcctcatctatggtaacaacaatcggccctcaggggtccctgaccgattctctggctccaagtctggcacctcagcctccctggccatcagtgggctccggtccgaggatgaggctgattattacgtgcggctcacgatgacggcctagccggtaccgtgttcggcggaggaaccaagctgacggtcctaggtgattataaagatgatgatgataaagcggccgcccatcatcatcatcat

SEQ ID NO: 19 - DNA, 707 bp, Artificial Sequence
  F8 mutated clone 2-4
gaggtgcagctgttggagtctgggggaggcttggtacagcctggggggtccctgagactctcctgtgcagcctctggattcacctttagtaactatttcatgagctgggtccgccaggctccagggaagggactggggtgggtctcaggtattagtggtaacggtggttacacatacttcgcagactccgtgaaggaccggttcaccatctccagagacaattccaagaacacgctgtatctgcaaatgaacagcctgagagccgaggacacggccgtgtattactgtgcgggaggtgatggcggtgcttggtccttctggggccaaggtacactggtcaccgtgagcagcggtggaggcggttcaggcggaggtggatccggcggtggcggatcgcagtctgtgctgactcagccaccctcagcgtctgggacccccgggcagagggtcaccatctcttgcactgggagcagctccaacatcggggcaggtcatgatgtacactggtatcagcagctcccaggaacggcccccaaactcctcatctatggtaacaacaatcggccctcaggggtccctgaccgattctctggctccaagtctggcacctcagcctccctggccatcagtgggctccggtccgaggatgaggctgattattactgtgcggctcttgatgacactgtaaagtggtactgtgttcggcg

SEQ ID NO: 20 - DNA, 803 bp, Artificial Sequence
  F8 mutated clone 2-12
gaggtgcagctgttggagtctgggggaggcttggtacagcctggggggtccctgagactctcctgtgcagcctctggattcacctttagtaactattatatggcctgggtccgccaggctccagggaagggactagagtgggtctcaggtattagtggtaacggtggttacacatacttcgcagactccgtgaaggaccggttcaccatctccagagacaattccaagaacacgctgtatctgcaaatgaacagcctgagagccgaggacacggccgtgtattactgtgcgggaggtggtgccagcgcttggtccttctggggccaaggtacactggtcaccgtgagcagcggtggaggcggttcaggcggaggtggatccggcggtggcggatcgcagtctgtgctgactcagccaccctcagcgtctgggacccccgggcagagggtcaccatctcttgcactgggagcagctccaacatcggggcaggttttgatgtatactggtatcagcagctcccaggaacggcccccaaactcctcatctatggtaacaacaatcggccctcaggggtccctgaccgattctctggctccaagtctggcacctcagcctccctggccatcagtgggctccggtccgaggatgaggctgattattactgtgcggctcatgatgacgtccataagcggtcgggtgttcggcggagcaaccaagctgacggtcctaggtgattataaagatgatgatgataaagcggccgccatcatcatcatcatcattgatcaccgcggtggcaatt

SEQ ID NO: 21 - DNA, 792 bp, Artificial Sequence
  F8 mutated clone 2-15
gaggtgcagctgttggagtctgggggaggcttggtacagcctggggggtccctgagactctcctgtgcagcctctggattcacctttagtaactattacatggcttgggtccgccaggctccagggaagggactggagtgggtctcaggtattagtggtaacggtggttacacatacttcgcagactccgtgaaggaccggttcaccatctccagagacaattccaagaacacgctgtatctgcaaatgaacagcctgagagccgaggacacggccgtgtattactgtggggaggtgatggcactagttggtccttctggggccaaggtacactggtcaccgtgagcagcggtggaggcggttcaggcggaggtggatccggcggtggcggatcgcagtctgtgctgactcagccaccctcagcgtctgggacccccgggcagagggtcaccatctcttgcactgggagcagctccaacatcggggcaggtcacgatgtacactggtatcagcagctcccaggaacggcccccaaactcctcatctatggtaacaacaatcggccctcaggggtccctgaccgattctctggctccaagtctggcacctcagcctccctggccatcagtgggctccggtccgaggatgaggctgattattactgtgcggcttttgatgacaccattagtggtcccgtgttcggcggaggaacaagctgacggtcctaggtgattataaagatgatgatgataaagcggccgcccatcatcatcatcatcattgatcaccgcg

SEQ ID NO: 22 - DNA, 722 bp, Artificial Sequence
  F8 mutated clone 2-20
gaggtgcagctgttggagtctgggggaggcttggtacagcctggggggtccctgagactctcctgtgcagcctctggattcacctttagtaactatcacatgagtgggtccgccaggctccagggaagggactggagtgggtctcaggtattagtggtaacggtggttacacatacttcgcagactccgtgaaggaccggttcaccatctccagagacaattccaagaacacgctgtatctgcaaatgaacagcctgagagccgaggacacggccgtgtattactgtgcgggaggtgatggtggtggttggtccttctggggccaaggtacactggtcaccgtgagcagcggtggaggcggttcaggcggaggtggatccggcggtggcggatcgcagtctgtgctgactcagccaccctcagcgtctgggacccccgggcagagggtcaccatctcttgcactgggagcagctccaacatcggggcaggtcacgatgtacactggtatcagcagctcccaggaacggcccccaaactcctcatctatggtaacaacaatcggccctcaggggtccctgaccgattctctggctccaagtctggcacctcagcctccctggccatcagtgggctccggtccgaggatgaggctgattattactgtgcggcttatgatgacagtattagtggtcaggtgttcggcggagaaccaagctgacgg

SEQ ID NO: 23 - DNA, 637 bp, Artificial Sequence
  F8 mutated clone 2-16
gaggtgcagctgttggagtctgggggaggcttggtacagcctggggggtccctgagactctcctgtgcagcctctggattcacctttagtaactattttatgggctgggtccgccaggctccagggaagggactggagtgggtctcaggtattagtggtaacggtggttacacatacttcgcagactccgtgaaggaccggttcaccatctccagagacaattccaagaacacgctgtatctgcaaatgaacagcctgagagccgaggacacggccgtgtattactgtgcgggaggtgatactggcagttggtccttctgggccaaggtacactggtcaccgtgagcagcggtggaggcggttcaggcggaggtggatccggcggtggcggatcgcagtctgtgctgactcagccaccctcagcgtctgggacccccgggcagagggtcaccatctcttgcactgggagcagctccaacatcggggcaggttacgatgtattttggtatcagcagctcccaggaacggcccccaaactcctcatctatggtaacaacaatcggccctcaggggtccctgaccgattctctggctccaagtctggcacctcagcctccctgggcatcagtgggctccg

SEQ ID NO: 24 - DNA, 796 bp, Artificial Sequence
  F8 mutated clone 2-18
gaggtgcagctgttggagtctgggggaggcttggtacagcctggggggtccctgagactctcctgtgcggcctctggattcacctttagtaactatcttatggcttgggtccgccaggctccagggaagggactggagtgggtctcaggtattagtggtaacggtggttacacatacttcgcagactccgtgaaggaccggttcaccatctccagagacaattccaagaacacgctgtatctgcaaatgaacagcctgagagccgaggacacggccgtgtattactgtgcgggaggtgatactactggttggtccttctggggccaaggtacactggtcaccgtgagcagcggtggaggcggttcaggcggaggtggatccggcggtggcggatcgcagtctgtgctgactcagccaccctcagcgtctgggacccccgggcagagggtcaccatctcttgcactgggagcagctccaacatcggggcaggttttgatgtacactggtatcagcagctcccaggaacggcccccaaactcctcatctatggtaacaacaatcggccctcaggggtccctgaccgattctctggctccaagtctggcacctcagcctccctggccatcagtgggctccggtccgaggatgaggctgattattactgtgcggctctcgatgacactctcgctggtatggtgttcggcggaggaaccaagctgacggtcctaggtgattataaagatgatgatgataaagcggccgcccatcatcatcatcatcattgatcaccgcggt

SEQ ID NO: 25 - DNA, 210 bp, Artificial Sequence
  F8 mutated clone 1-4 (2nd incidence)
gaggtgcagctgttggagtctgggggaggcttggtacagcctggggggtccctgagactctcctgtgcagcctctggattcacctttagtaactatcacatgggctgggtccgccaggctccagggaagggactggagtgggtctcaggtattagtggtaacggtggttacacatacttcgcaaactccgtgaaggaccggttcaccatc

SEQ ID NO: 26 - DNA, 70 bp, Artificial Sequence
  Derived from IgG originating from DP-47 (IGHV3-23) germline gene
ggtctcagctattagtggtagtggtggtagcacatactacgcagactccgtgaagggccggttcaccatc

SEQ ID NO: 27 - DNA, 70 bp, Artificial Sequence
  Derived from IgG originating from DP-47 (IGHV3-23) germline gene
ggtctcaggtattagtggtaacggtggttacacatacttcgcagactccgtgaaggaccggttcaccatc

SEQ ID NO: 28 - DNA, 70 bp, Artificial Sequence
  Derived from IgG originating from DP-47 (IGHV3-23) germline gene
ggtctcagctattggtggtggtggaagtaacacatactacacagactccgtgaagggccggttcaccatc

SEQ ID NO: 29 - DNA, 70 bp, Artificial Sequence
  Derived from IgG originating from DP-47 (IGHV3-23) germline gene
ggtctcaagtattagtggaggtggtgataatacaaaatacgcagactctgtgaagggccggttcaccatc

SEQ ID NO: 30 - DNA, 70 bp, Artificial Sequence
  Derived from IgG originating from DP-47 (IGHV3-23) germline gene
ggtctcagctatttttagtggtggttatagcacatactacgcagactccgtgaagggccggttcaccatc

SEQ ID NO: 31 - DNA, 70 bp, Artificial Sequence
  Derived from IgG originating from DP-47 (IGHV3-23) germline gene
ggtctcaggagttagtaagagtggtgagactacatactatacagactccgtgaagggccggttcaccatc

SEQ ID NO: 32 - DNA, 70 bp, Artificial Sequence
  Derived from IgG originating from DP-47 (IGHV3-23) germline gene
ggtctcagttattagtggtagtggtactatcacatactacgcagactccgtgaagggccggttcaccatc

SEQ ID NO: 33 - DNA, 70 bp, Artificial Sequence
  Derived from IgG originating from DP-47 (IGHV3-23) germline gene
ggtctcaggtcttagtggtagtggtggtcgcacatactatgcagactccgtgaagggccggtgcaccatc

SEQ ID NO: 34 - DNA, 70 bp, Artificial Sequence
  Derived from IgG originating from DP-47 (IGHV3-23) germline gene
ggtctcagctgttaatggtggtggtggtaaaacatactacgcagactccgtgaagggccggttcaccatc

SEQ ID NO: 35 - DNA, 70 bp, Artificial Sequence
  Derived from IgG originating from DP-47 (IGHV3-23) germline gene
ggtcgcagcaattagtggtagtggtggcagcacatactacgcaaactccgtgaggggccgcttcaccatt

SEQ ID NO: 36 - DNA, 70 bp, Artificial Sequence
  Derived from IgG originating from DP-47 (IGHV3-23) germline gene
ggtctcaagtattagtgatagtagtgccagcacattctacgcagactccgtgaagggccggttcaccatc

SEQ ID NO: 37 - DNA, 70 bp, Artificial Sequence
  Derived from IgG originating from DP-47 (IGHV3-23) germline gene
ggtctcagctattagtggtaatggtggtagcacatactacgcagactccgtgaagggccgattcaccatc

SEQ ID NO: 38 - DNA, 70 bp, Artificial Sequence
  Derived from IgG originating from DP-47 (IGHV3-23) germline gene
ggtctcaactataactgataatggtggtagcacatacgacgcagactccgtgaagggccggttcaccatc

SEQ ID NO: 39 - DNA, 70 bp, Artificial Sequence
  Derived from IgG originating from DP-47 (IGHV3-23) germline gene
ggtcgctactattagtgggagtggtgataaaacatactacgcagacttcgtgaggggccggttcaccatc

SEQ ID NO: 40 - DNA, 70 bp, Artificial Sequence
  Derived from IgG originating from DP-47 (IGHV3-23) germline gene
gatctcagctgtcagtggtgatggtgatggtgcttactacgcagactccgtgaagggccggttcaccatc

SEQ ID NO: 41 - DNA, 70 bp, Artificial Sequence
  Derived from IgG originating from DP-47 (IGHV3-23) germline gene
ggtctcgactattaatggtggtggtcggagtacatattacccagactccgtgaagggccggttcaccatc

SEQ ID NO: 42 - DNA, 70 bp, Artificial Sequence
  Derived from IgG originating from DP-47 (IGHV3-23) germline gene
ggtctcagctattagtggcagtggtgggagcacatactacgcagactccgtgaagggccggttcaccatc

SEQ ID NO: 43 - DNA, 70 bp, Artificial Sequence
  Derived from IgG originating from DP-47 (IGHV3-23) germline gene
ggtctcaactattactgctggtcatggtgacacatcctacgcagactccgtgaggggccggttcaccatc

SEQ ID NO: 44 - DNA, 70 bp, Artificial Sequence
  Derived from IgG originating from DP-47 (IGHV3-23) germline gene
ggtcgcagctatcagtgctggtggtggtggcacatactacgcagactccgtgaagggccggttcaccatc

SEQ ID NO: 45 - DNA, 70 bp, Artificial Sequence
  Derived from IgG originating from DP-47 (IGHV3-23) germline gene
tgtctcaggtgtgagtgatagtgggggtagcacatattacgcagactccgtgaaggggcggttcaccatc

SEQ ID NO: 46 - DNA, 70 bp, Artificial Sequence
  Derived from IgG originating from DP-47 (IGHV3-23) germline gene
ggtctcagcaattagtgggagtacttatagtacacactacgcagactccgtgaggggccgcttcaccatc

SEQ ID NO: 47 - DNA, 70 bp, Artificial Sequence
  Derived from IgG originating from DP-47 (IGHV3-23) germline gene
ggtctcaagtattagtggaagtggtgctagcacctactactcagagtccgtgaacggccggttcactatc

SEQ ID NO: 48 - DNA, 70 bp, Artificial Sequence
  Derived from IgG originating from DP-47 (IGHV3-23) germline gene
ggtctcatctattagtggcagtggtggcagcacatattacgcagactccgtgaagggccggttcaccatc

SEQ ID NO: 49 - DNA, 70 bp, Artificial Sequence
  Derived from IgG originating from DP-47 (IGHV3-23) germline gene
ggtctcagctattagtggtagtggtggtagcacacactacgcagactccgtgaagggccggttcaccatc

SEQ ID NO: 50 - DNA, 70 bp, Artificial Sequence
  Derived from IgG originating from DP-47 (IGHV3-23) germline gene
ggtcttagtaattagtggtagtggtggtagtacatactacgcagactccgtgaagggccggttcaccatc

SEQ ID NO: 51 - DNA, 70 bp, Artificial Sequence
  Derived from IgG originating from DP-47 (IGHV3-23) germline gene
ggtctcaggtattagtgatgatggtggtaccacatactacgtagactccgtgaagggccggttcaccatc

SEQ ID NO: 52 - DNA, 70 bp, Artificial Sequence
  Derived from IgG originating from DP-47 (IGHV3-23) germline gene
ggtcgcagctattagtggtagtggtattagcacatattacgcagactccgtgaagggccggttcaccatt

SEQ ID NO: 53 - DNA, 70 bp, Artificial Sequence
  Derived from IgG originating from DP-47 (IGHV3-23) germline gene
ggtctcttctatcaataatgatggtactggcacattctacgcagactccgtgaagggccggttcaccatc

SEQ ID NO: 54 - DNA, 70 bp, Artificial Sequence
  Derived from IgG originating from DP-47 (IGHV3-23) germline gene
ggtcacatctattagtggtaatggtgtgatcacatactacgcagactccgtgaagggccggttcaccatc

SEQ ID NO: 55 - DNA, 70 bp, Artificial Sequence
  Derived from IgG originating from DP-47 (IGHV3-23) germline gene
ggtctcatctattagtggaactggtgatttcacgtcctacgcagactccgtagagggccggttcaccgtc

SEQ ID NO: 56 - DNA, 70 bp, Artificial Sequence
  Derived from IgG originating from DP-47 (IGHV3-23) germline gene
ggtctcatatattagtggaaatgatgacagcatatattatggagactccgtgaagggccggttcaccatc

SEQ ID NO: 57 - DNA, 70 bp, Artificial Sequence
  Derived from IgG originating from DP-47 (IGHV3-23) germline gene
ggtctcaattattgatgctagtggtgagaccacatactacgcagactccgtgaggggccggttcaccatc

SEQ ID NO: 58 - DNA, 70 bp, Artificial Sequence
  Derived from IgG originating from DP-47 (IGHV3-23) germline gene
ggtctcatatattagcggtaattttgatagcatatattatgcagactccgtgaagggccggttcaccatc